(19) United States
(12) Patent Application Publication
(10) Pub. No.: US 2008/0259031 A1
(43) Pub. Date: Oct. 23, 2008

(54) CONTROL APPARATUS, METHOD, AND PROGRAM

(75) Inventor: Tatsuo YOSHINO, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/104,973

(22) Filed: Apr. 17, 2008

(30) Foreign Application Priority Data
Apr. 18, 2007 (JP) 2007-109675

(51) Int. Cl. G09G 5/08

(52) U.S. Cl. 345/158

(57) ABSTRACT

There is provided an intuitive, easy-to-use operation interface that is less liable to erroneous operations and is operated by a motion of a user. A motion operation mode is entered in response to recognition of a particular motion (preliminary motion) of a particular object in a video image and, after that, operation of any of various devices is controlled in accordance with various command motions recognized in a motion area being locked on. When an end command motion is recognized or after the motion area is unable to be recognized for a predetermined period of time, the lock-on is canceled to exit the motion operation mode.

### BACKGROUND OF THE INVENTION

1. Field of the Invention

The present invention relates to a control apparatus, method, and program.

2. Description of the Related Art

According to Japanese Patent Application Laid-Open No. 8-44490, a host computer which recognizes the shape and motion of an object in an image captured by a CCD camera and a display which displays the shape and motion of the object recognized by the host computer are provided. When a user faces the CCD camera and gives a command with a hand signal, for example, the hand signal is displayed on the display screen of the display to allow a virtual switch, for example, displayed on the display screen to be selected with an arrow cursor icon, thereby enabling very easy operation of a device without requiring an input device such as a mouse.

Japanese Patent Application Laid-Open No. 9-185456 provides an motion recognition unit which recognizes the shape and motion of an object in a captured image, a display which displays the shape and motion of the object recognized by the motion recognition unit, a frame memory which stores an image captured by a CCD camera, and a reference image memory which stores an image captured before the image stored in the frame memory was captured. The motion recognition unit extracts a difference between the image stored in the frame memory and the reference image stored in the reference image memory.

According to Japanese Patent Application Laid-Open No. 2002-149302, an apparatus includes an object detection unit which detects a particular object in a moving video image captured by a camera, a motion direction recognition unit which recognizes the direction of motion of the object detected by the object detection unit, and a command output unit which outputs a command corresponding to the motion direction recognized by the motion direction recognition unit to an information processing system. The apparatus further includes a position information output unit which detects the position of the object detected by the object detection unit and provides the result of the detection to an operator operating the information processing system as position information.

According to Japanese Patent Application Laid-Open No. 2004-349915, a scene such as a room is shot with a video camcorder and a gray-scale signal is sent to an image processing device. The image processing device extracts the shape of a human body and sends it to a motion recognition device, where a moving object such as a human body is recognized. Examples of motions include handshapes, motion of eyes, and the direction indicated by a hand. Examples of handshapes include lifting one finger to receive television channel 1 and lifting two fingers to receive television channel 2.

### SUMMARY OF THE INVENTION

The related-art techniques described above have an advantage that, unlike key operations on an infrared remote control, operations can be intuitively performed while watching a display screen.

However, the related-art techniques involve a complicated technique of performing recognition of the shapes and motions of objects in various environments and therefore unexpected malfunctions can occur due to misrecognition caused by object detection failure or erroneous recognition of an involuntary motion of an operator.

An object of the present invention is to provide an intuitive, easy-to-use operation interface that is less liable to erroneous operations and is operated by a motion of a user.

The present invention provides a control apparatus which controls an electronic device, comprising: a video image obtaining unit which continuously obtains a video signal a subject of which is a particular object; a command recognition unit which recognizes a control command relating to control of the electronic device, the control command being represented by at least one of a particular shape and motion of the particular object from a video signal obtained by the video image obtaining unit; a command mode setting unit which sets a command mode for accepting the control command; and a control unit which controls the electronic device on the basis of a control command recognized by the command recognition unit, in response to the command mode setting unit setting the command mode.

According to this aspect of the present invention, because the electronic device is controlled on the basis of a control command recognized by the command recognition unit in response to setting of the command mode, a user's involuntary motion is prevented from been misrecognized as a control command and the electronic device is prevented from being accidentally controlled when the command mode is not set.

Furthermore, once the command mode is set, a control command relating to the electronic device can be provided by at least one of a particular shape and motion of a particular object, therefore an intuitive, easy-to-use operation interface can be provided.

Preferably, the command recognition unit recognizes an end command to end the command mode from a video signal obtained by the video image obtaining unit, the end command being represented by at least one of a particular shape and motion of the particular object; and the command mode setting unit cancels the set command mode in response to the command recognition unit recognizing the end command.

Preferably, the command recognition unit recognizes a preliminary command from a video signal obtained by the video image obtaining unit, the preliminary command being represented by at least one of a particular shape and motion of the particular object; and the command mode setting unit sets the command mode in response to the command recognition unit recognizing the preliminary command.

Preferably, the command mode setting unit sets the command mode in response to a manual input operation instructing to set the command mode.

The present invention provides a control apparatus which controls an electronic device, comprising: a video image obtaining unit which continuously obtains a video signal a subject of which is a particular object; a command recognition unit which recognizes a preliminary command and a control command relating to control of the electronic device from a video signal obtained by the video image obtaining unit, the preliminary command and the control command being represented by at least one of a particular shape and motion of the particular object; and a control unit which controls the electronic device on the basis of a control command recognized by the command recognition unit, in response to the command recognition unit recognizing the preliminary command; wherein the command recognition unit tracks an area in which a preliminary command by the particular object is recognized from the video signal, and recognizes the control command from the area.

According to this aspect of the present invention, because the area in which a preliminary command by a particular object is recognized from the video signal is tracked and a control command is recognized in the area, a control command from a particular user can be accepted and the possibility that a shape or motion of other person or object is mistakenly recognized as a control command can be reduced.

Preferably, the control apparatus further comprises a thinning unit which thins a video signal obtained by the video image obtaining unit; wherein the command recognition unit recognize the preliminary command from a video signal thinned by the thinning unit and recognizes the control command from a video signal obtained by the video image obtaining unit.

With this configuration, the load of recognition of the preliminary command is reduced and therefore the recognition can be performed faster, and the control command can be accurately recognized.

Preferably, the control apparatus further comprises an extraction unit which extracts feature information from the area; wherein the command recognition unit tracks the area on the basis of feature information extracted by the extraction unit.

The present invention provides a control apparatus which controls an electronic device, comprising: a video image obtaining unit which continuously obtains a video signal a subject of which is a particular object; a command recognition unit which recognizes a preliminary command and a control command relating to control of the electronic device from a video signal obtained by the video image obtaining unit, the preliminary command and the control command being represented by at least one of a particular shape and motion of the particular object; a command mode setting unit which sets a command mode for accepting the control command, in response to the command recognition unit recognizing the preliminary command; and a control unit which controls the electronic device on the basis of the control command in response to the command mode setting unit setting the command mode; wherein the command recognition unit, in response to the command mode setting unit setting the command mode, tracks an area in which a preliminary command by the particular object is recognized from the video signal and recognizes the control command from the tracked area.

The command recognition unit tracks an area in which a first preliminary command by the particular object is recognized from the video signal, and recognizes the second preliminary command from the area; and the command mode setting unit sets the command mode in response to the command recognition unit recognizing the first and second preliminary commands.

Multiple second preliminary commands may be provided and a second preliminary command that corresponds to an electronic device to control may be recognized.

The preliminary command is represented by a shape of the particular object and the control command is represented by a motion of the object.

Alternatively, the first preliminary command is represented by wagging of a hand with a finger extended and the second preliminary command is represented by forming a ring by fingers.

Preferably, the command recognition unit recognizes an end command to end the command mode from the video signal; and the command mode setting unit cancels the set command mode in response to the command recognition unit recognizing the end command.

With this, the user can cancel the command mode at the user's disposal to prevent an involuntary motion from being mistakenly recognized as a control command.

The end command is represented by a to-and-fro motion of the center of gravity, an end, or the entire outer surface of an image of the particular object.

For example, the end command is represented by wagging of a hand with a plurality of fingers extended.

The command recognition unit recognizes a selection command to select a menu item that depends on a direction and amount of rotation of the center of gravity, an end, or the entire outer surface of the particular object.

For example, the selection command is represented by rotation of a hand with a finger extended.

The command recognition unit recognizes a selection confirmation command to confirm selection of a menu item from a particular shape of the particular object.

The selection confirmation command is represented by formation of a ring by fingers, for example.

The control apparatus may further comprise a setting indicating unit which indicates status of setting of the command mode, that is, whether the command mode is set or not.

The present invention provides a control method for controlling an electronic devices, comprising the steps of: continuously obtaining a video signal a subject of which is a particular object; recognizing a control command relating to control of the electronic device from a video signal obtained, the control command being represented by at least one of a particular shape and motion of the particular object; setting a command mode for accepting the control command; and controlling the electronic device on the basis of the set control command, in response to setting of the command mode.

The present invention provides a control method for controlling an electronic device, comprising the steps of: continuously obtaining a video signal a subject of which is a particular object; recognizing a preliminary command represented by at least one of a particular shape and motion of the particular object from the video signal; and tracking an area in which the preliminary command is recognized from the video signal and recognizing a control command represented by at least one of a particular shape and motion of the particular object from the area; and controlling the electronic device on the basis of the recognized control command.

The present invention provides a control method for controlling an electronic device, comprising the steps of: continuously obtaining a video signal a subject of which is a particular object; recognizing a preliminary command represented by at least one of a particular shape and motion of the particular object from a video signal obtained; setting a command mode for accepting the control command, in response to recognition of the preliminary command; in response to setting of the command mode, tracking an area in which the preliminary command is recognized and recognizing a control command relating to control of the electronic device from the tracked area; and controlling the electronic device on the basis of the control command.

The present invention also provides a program that causes a computer to execute any of the control methods described above.

According to the present invention, because the electronic device is controlled based on a control command recognized in response to setting of the command mode, a user's involuntary body motion is prevented from being mistakenly recognized as a control command and the electronic device is prevented from being mistakenly controlled when the command mode is not set.

Furthermore, once the command mode is set, a control command related to control of the electronic device can be provided by at least one of a particular shape and motion of a particular object. Thus, an intuitive, easy-to-use operation interface can be provided.

### BRIEF DESCRIPTION OF THE DRAWINGS

FIG. 1 is a block diagram of a video/audio communication system;

FIG. 2 is a block diagram of a communication terminal;

FIG. 3 shows one example of a display screen displayed on a monitor 5;

FIG. 4 is a conceptual diagram of a full-screen own video image display mode;

FIG. 5 is a conceptual diagram of a full-screen correspondent video image display mode;

FIG. 6 is a conceptual diagram of a PoutP screen (normal interaction) display mode;

FIG. 7 is a conceptual diagram of a PoutP screen (content interaction 1) display mode;

FIG. 8 is a conceptual diagram of a PoutP screen (content interaction 2) display mode;

FIG. 9 is a conceptual diagram of a full-screen (content interaction 3) display mode;

FIG. 10 is a conceptual diagram of tiles defining display areas;

FIG. 11 is a detailed block diagram of an encoding unit;

FIG. 12 is a detailed block diagram of a control unit section;

FIG. 13 shows an example of a candidate body motion area;

FIG. 14 shows an example of a symbolized candidate body motion area;

FIG. 15 shows exemplary first and second preliminary motions;

FIGS. 16A to 16C show an exemplary trajectory of an observation point having a particular shape recognized;

FIG. 17 shows connections of a communication terminal, a monitor, a microphone, and a camera;

FIG. 18 schematically shows a flow of packets input from a communication terminal into an AV data input terminal of the monitor;

FIG. 19 shows blocks of a communication terminal and a monitor relating to transmission and reception of packets;

FIGS. 20A and 20B show an exemplary structure of a packet;

FIG. 21 shows an exemplary operation menu screen;

FIG. 22 shows an exemplary address book screen;

FIG. 23 shows an exemplary send operation screen;

FIG. 24 shows exemplary menu items and operation command marks on a PoutP screen (normal interaction);

FIG. 25 shows exemplary menu items and an operation command mark on a PoutP screen (content interaction);

FIG. 26 shows exemplary menu items (main items) on a television receiving screen;

FIG. 27 shows exemplary menu items (channel selection items) on a television receiving screen;

FIG. 28 is a flowchart showing a flow of a process for recognizing a motion area; and

FIG. 29 is a flowchart showing a flow of a process for recognizing a second-preliminary motion.

### DETAILED DESCRIPTION OF THE PREFERRED EMBODIMENTS

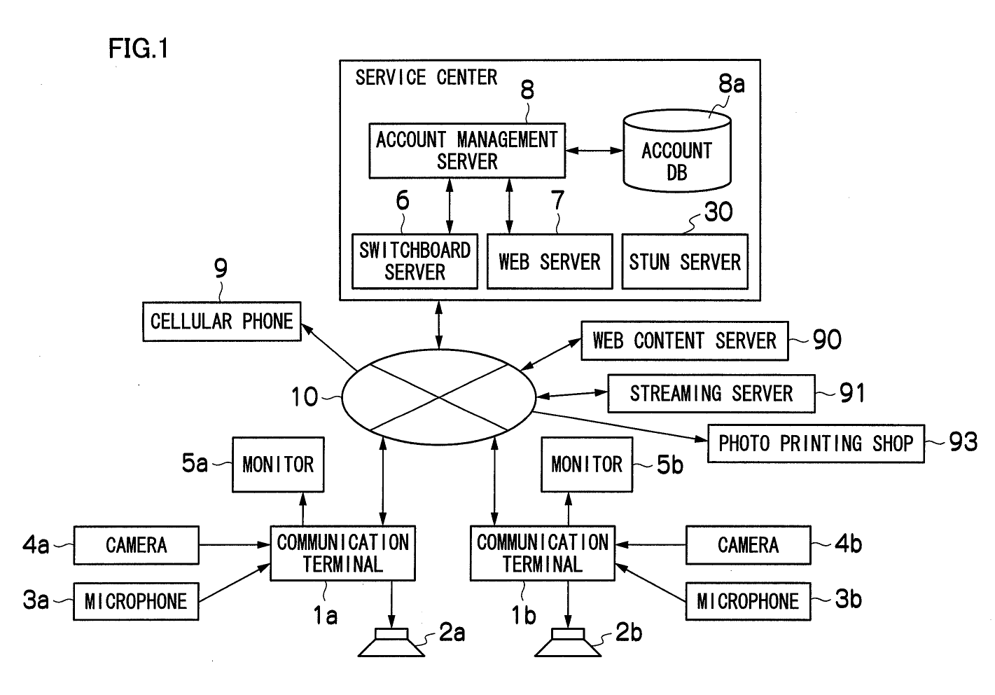

FIG. 1 is a block diagram of a video/audio communication system according to a preferred embodiment of the present invention. In the video/audio communication system, communication terminals 1a and 1b having equivalent configurations are interconnected through a network 10 such as the Internet and sends and receive video and audio data to and from each other.

It should be noted that the communication terminals 1a and 1b have configurations similar to each other and are distinguished from each other only for the sake of identification of the terminals with which communication is performed and that the all or part of their roles are interchangeable in the following description. When there is no need to distinguish the communication terminals from each other as a terminal with which communication is performed through the network, they will be sometimes collectively referred to as communication terminal 1.

The network 10 is a network such as the Internet connected to a network such as a broadband network such as an ADSL, fiber-to-the-home (FTTH), or cable television network, or a narrowband network such as an ISDN network, or a radio communication network such as an IEEE 802.xx-compliant network such as Ultra Wide Band (UWB) or Wireless Fidelity (Wi-Fi) network.

It is assumed in the present embodiment that the network 10 is a best-effort network, which does not guarantee that a predetermined bandwidth (communication speed) is always ensured. The nominal maximum bandwidth of the network 10 can be practically restricted by various factors such as the distance between a telephone switching station and home, the communication speed between ADSL modems, variations in traffic, and the communication environment of the party with which a session is established. The effective bandwidth often decreases to a fraction of a nominal value. The bandwidth of the network 10 is expressed in bits per second (bps). For example, a typical nominal bandwidth of FTTH networks is 100 Mbps but is sometimes limited to several hundred Kbps in effect.

A connection path between communication terminals 1a and 1b is specified by a switchboard server 6, which is an SIP (Session Initiation Protocol) server, by using network addresses (such as global IP addresses), ports, and identifiers (such as MAC addresses). Information about the users of communication terminals 1 such as names and e-mail addresses and information about connection of the communication terminals 1 (account information) are stored in an account database (DB) 8a and managed by an account management server 8. The account information can be updated, changed, and deleted from a communication terminal 1 connected to the account management server 8 through a Web server 7. The Web server 7 also functions as a mail server which transmits mail and a file server which downloads files.

Communication terminal 1a is connected with a microphone 3a, a camera 4a, a speaker 2a, and a monitor 5a. Sound picked up by the microphone 3a and images captured with the camera 4a are transmitted to communication terminal 1b through the network 10. Similarly, communication terminal 1b is connected with a microphone 3b, a camera 4b, a speaker 2b, and a monitor 5b and is capable of transmitting video and audio to communication terminal 1a.

Video and audio received at the communication terminal 1b is output to the monitor 5b and the speaker 2b, respectively; video and audio received at communication terminal 1a are output to the monitor 5a and the speaker 2a, respectively. The microphone 3 and speaker 2 may be integrated into a headset. Alternatively, the monitor 5 may also function as a television receiver.

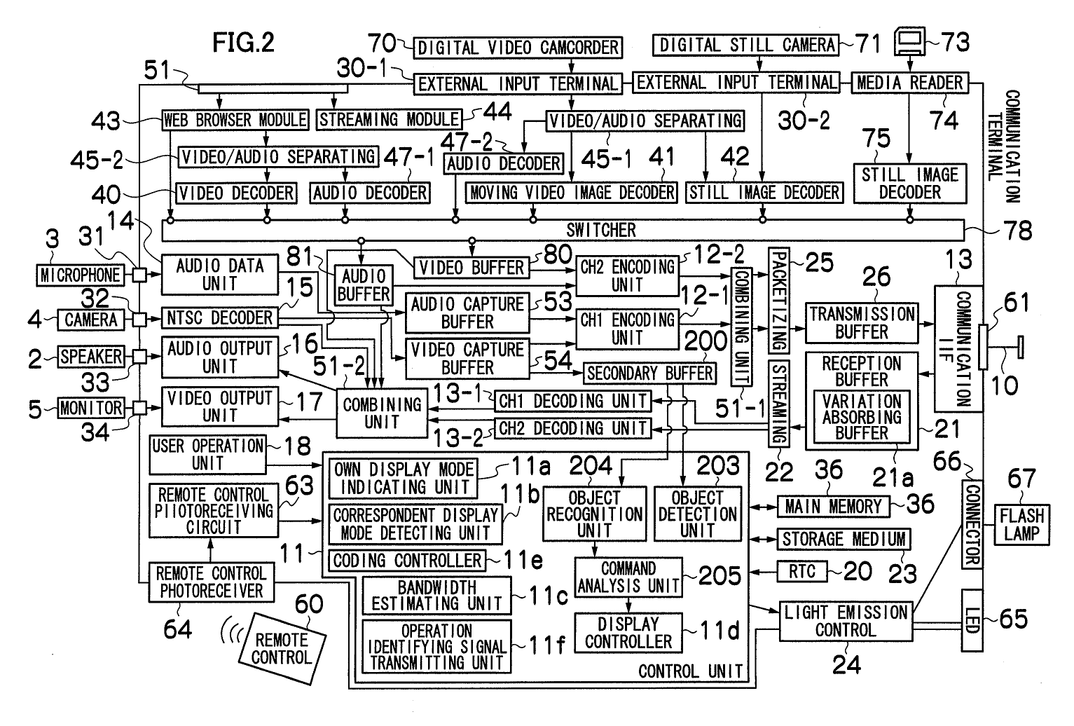

FIG. 2 is a block diagram showing in detail a configuration of the communication terminal 1.

Provided on the exterior of the body of the communication terminal 1 are an audio input terminal 31, a video input terminal 32, an audio output terminal 33, and a video output terminal 34, which are connected to a microphone 3, a camera 4, a speaker 2, and a monitor 5, respectively.

External input terminal 30-1, which is an IEEE 1394-based input terminal, receives inputs of moving video image/still image/audio data compliant with DV or other specifications from the digital video camcorder 70. External input terminal 30-2 receives inputs of still images compliant with JPEG or other specifications from the digital still camera 71.

An audio signal input in an audio data unit 14 from the microphone 3 connected to the audio input terminal 31 and a color-difference signal generated by an NTSC decoder 15 are digital-compression-coded by a CH1 encoding unit 12-1 formed by a high-image-quality encoder such as an MPEG-4 encoder into stream data (content data of a format that can be delivered in real-time). The stream data is referred to as CH1 stream data.

A CH2 encoding unit 12-2 formed by a high-quality encoder such as an MPEG-4 encoder digital-compression-encodes into stream data a video signal including one of a still image or moving video image downloaded from a Web content server 90 by a Web browser module 43, a still image or moving video image from a digital video camcorder 70, a still image or moving video image from a digital still camera 71, a moving video image downloaded by a streaming module 44 from a streaming server 91, and a moving video image or still image from a recording medium 73 whichever input source that is enabled by a switcher 78 to input data (hereinafter these image input sources are sometimes simply referred to as a video content input source such as a digital video camcorder 70), and an audio signal including audio downloaded by the streaming module 44 from the streaming server 91 or audio from the digital video camcorder 70, whichever input source that is enabled by the switcher 78 to input data (hereinafter these audio input sources are sometimes simply referred to as an audio input source such as a digital video camcorder 70). The stream data is referred to as CH2 stream data.

The CH2 encoding unit 12-2 has the function of converting a still image input from an input source such as a digital video camcorder 70 into a moving video image and outputting the image. The function will be described later in detail.

A combining unit 51-1 combines CH1 stream data with CH2 stream data to generate combined stream data and outputs it to a packetizing unit 25.

The combined stream data is packetized by the packetizing unit 25 and temporarily stored in a transmission buffer 26. The transmission buffer 26 sends packets onto the network 10 at predetermined timing through a communication interface 13. The transmission buffer 26 has the capability of storing one frame of data in one packet and sending out the packet when moving video images are input at a rate of 30 frames per second.

In the present embodiment, reduction of transmission frame rate, that is, frame thinning, is not performed even when a decrease in the transmission bandwidth of the network 10 is expected.

A video/audio data separating unit 45-1 separates combined data input from the external input terminal 30-1 into video data and audio data.

Moving video image data or still image data separated by the video/audio data separating unit 45-1 is decoded by a moving video image decoder 41 or a still image decoder 42 and then temporarily stored in a video buffer 80 as a frame image at predetermined time intervals. The number of frames stored per second in the video buffer 80 (frame rate) needs to be matched to the frame rate (for example 30 fps (frames per second)) of a video capture buffer 54, which will be described later.

Audio data separated by the video/audio data separating unit 45-1 is decoded by an audio decoder 47-2 and then temporarily stored in an audio buffer 81.

The NTSC decoder 15 is a color decoder that converts an NTSC signal input from a camera 4 to a luminance signal and a color-difference signal. In the NTSC decoder 15, a Y/C separating circuit separates an NTSC signal into luminance signal and a carrier chrominance signal and a color signal demodulating circuit demodulates the carrier chrominance signal to generate color-difference signals (Cb, Cr).

The audio data unit 14 converts an analog audio signal input from the microphone 3 to digital data and outputs it to an audio capture buffer 53.

The switcher (switching circuit) 78 switches a video to be input in the video buffer 80 to one of a moving video image or still image from a digital video camcorder 70, a still image from a digital still camera 71, and a moving video image or still image read by a media reader 74 from a recording medium 73, according to the control of a control unit 11.

A combining unit 51-2 combines a video from a video content input source such as a digital video camcorder 70 with moving video frame images decoded by a CH1 decoding unit 13-1 and CH2 decoding unit 13-2 and outputs the combined image to a video output unit 17. The combined image thus obtained is displayed on the monitor 5.

Preferably, the monitor 5 is a television monitor that displays television pictures received and includes multiple external input terminals. Switching between the external input terminals of the monitor 5 preferably can be made from a communication terminal 1. When a video signal to be input in the monitor 5 is switched from television to an external input to display a video content at a communication terminal 1, a TV control signal is sent from the communication terminal 1 to the monitor 5 and the monitor 5 switches to the external input that receives a video signal from the communication terminal 1 in response to the input of the TV control signal.

At a correspondent communication terminal 1, video data encoded by the CH1 encoding unit 12-1 and video data encoded by the CH2 encoding unit 12-2 are separately transformed to stream data by a streaming circuit 22 and then the stream data encoded by the CH1 encoding unit 12-1 is decoded in the CH1 decoding unit 13-1 into a moving video image or audio and the stream data encoded by the CH2 encoding unit 12-2 is decoded in the CH2 decoding unit 13-2 into a moving video image or audio. Then the decoded data are output to a combining unit 51-2.

The combining unit 51-2 resizes an image from a camera 4, which is an own video image, and a moving video image decoded by the CH1 decoding unit 13-1, which is a correspondent video image, and a moving video image decoded by the CH2 decoding unit 13-2, which is a video content so as to fit in their respective display areas on the display screen of the monitor 5 and combines the resized images. Resizing is performed in accordance with display mode switching provided from a remote control 60.

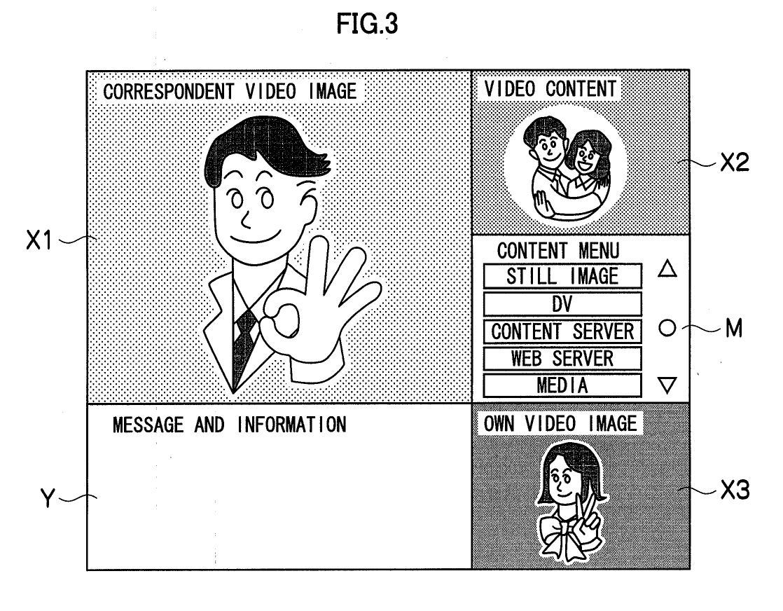

FIG. 3 shows an exemplary arrangement of video images displayed on the monitor 5. As shown, a video image (correspondent video image) from a camera 4 at a correspondent communication terminal 1 is displayed in a first display area X1, a video image input from a video content input source such as a digital video camcorder 70 at the correspondent communication terminal 1 is displayed in a second display area X2, and a video image (own video image) input from a camera 4 at the own communication terminal 1 is displayed in a third display area X3 on the monitor 5.

The images displayed on the first to third display areas X1 to X3 are not limited to those shown in FIG. 3 but change in accordance with a display mode setting, which will be described later.

Other items, such as a content menu M that lists video content input sources, such as a digital video camcorder 70, that input data to the own switcher 78 and other information, and a message and information display area Y that displays various messages and general information are displayed in a reduced size so that they fit in the screen and do not overlap each other.

While the display areas X1 to X3 on the display screen shown are displayed in split views at a predetermined area ratio, the screen can be split in various other ways. Also, all of multiple video images do not necessarily need to be displayed at a time on the screen. The display mode may be changed in response to a predetermined operation on the remote control 60 to display only an own video image, a correspondent video image, or a video content or a combination of some of these images may be displayed.

Any item in the content menu M can be selected by an operation on the remote control 60. The control unit 11 controls the switcher 78 to select a video content input source in response to an item selecting operation on the remote control 60. This enables any video image to be selected to display the image as a video content. Here, when the item “Web server” is selected, a Web content obtained by the Web browser module 43 from the Web content server 90 is displayed as the video content; when the item “Content server” is selected, a streaming content obtained by the streaming module 44 from the streaming server 91 is displayed as the video content; when the item “DV” is selected, a video image from a digital video camcorder 70 is displayed as the video content; when the item “Still” is selected, an image from a digital still camera 71 is displayed as the video content; and when the item “Media” is selected, a video image read from a recording medium 73 is displayed as the video content.

The CH1 encoding unit 12-1 sequentially compression-encodes captured audio data from the microphone 3 provided from an audio capture buffer 53 according to MPEG or the like. The coded audio data is packetized by the packetizing unit 25 and sent to the correspondent communication terminal 1 as a stream.

The CH2 encoding unit 12-2 compression-encodes one of audio from the streaming module 44 and audio from the digital video camcorder 70 (audio input source such as a digital video camcorder 70), that is selected as an audio input source by the switcher 78, according to a standard such as MPEG. The coded audio data is packetized by the packetizing unit 25 and sent to the correspondent communication terminal 1 as a stream.

The CH1 decoding unit 13-1 decides audio data encoded by the CH1 encoding unit 12-1. The CH2 decoding unit 13-2 decodes audio data encoded by the CH2 encoding unit 12-2.

The combining unit 51-2 combines audio data decoded by the CH1 decoding unit 13-1 with audio data decoded by the CH2 decoding unit 13-2 and outputs the combined audio data to an audio output unit 16. In this way, audio picked up with the microphone 3 of the correspondent communication terminal 1 and audio obtained from an input source such as a digital video camcorder 70 at the correspondent communication terminal 1 are reproduced by a speaker 2 of the own communication terminal 1.

A bandwidth estimating unit 11c estimates a transmission bandwidth from a factor such as jitter (variations) on the network 10.

A coding controller 11e changes the video transmission bit rates of the CH1 encoding unit 12-1 and the CH2 encoding unit 12-2 in accordance with the estimated transmission bandwidth. That is, when it is estimated that the transmission bandwidth is decreasing, the coding controller 11e decreases the video transmission bit rate; when it is estimated that the transmission bandwidth is increasing, the coding controller 11e increases the video transmission bit rate. This can prevent occurrence of packet losses due to packet transmission that exceeds the transmission bandwidth. Accordingly, smooth stream data transmission responding to changes in transmission bandwidth can be performed.

The specific bandwidth estimation by the bandwidth estimating unit 11c may be performed for example as follows. When RTCP packets of SR (Sender Report) type (RTCP SR) are received from correspondent communication terminal 1b, the bandwidth estimating unit 11c calculates the number of losses of received RTCP SR by counting lost sequence numbers in sequence number fields in the headers of RTCP SR packets. The bandwidth estimating unit 11c sends an RTCP packet of RR (Receiver Report) type (RTCP RR) in which the number of losses is written to the correspondent communication terminal 1. The time that has elapsed between the reception of RTCP SR and transmission of RTCP RR (referred to as response time for convenience) is also written in the RTCP RR.

When the correspondent communication terminal 1b receives the RTCP RR, the correspondent communication terminal 1b calculates RTT (Round Trip Time), which is the time between the transmission of the RTCP SR and the reception of the RTCP RR minus the response time. The communication terminal 1b refers to the number of sent packets in RTCP SR and the number of lost packets in RTCP RR and calculates the packet loss rate=(the number of lost packets)/(the number of sent packets) in an regular interval. The RTT and the packet loss rate constitute a communication condition report.

Appropriate time intervals at which a monitoring packet is sent may be 10 to several tens of seconds. Because it is often impossible to accurately estimate a network condition by a single try of packet monitoring, packet monitoring is performed a number of times and an average is taken to estimate, thereby improving the accuracy of the estimation. If the quantity of monitoring packets is too large, the monitoring packets themselves contribute to reduction of the bandwidth. Therefore, the quantity of monitoring packets is preferably 2 to 3% or less of the entire traffic.

Other than the method described above, various QoS (Quality of Service) control techniques can be used in the bandwidth estimating unit 11c to obtain the communication condition report. The bit rate for audio coding may be changed according to the estimated transmission bandwidth. However, there is no problem with using a fixed bit rate because the contribution ratio of the transmission bandwidth of audio is lower than that of video.

Packets of stream data received from the other communication terminal 1 through the communication interface 13 are temporarily stored in a reception buffer 21 and are then output to the streaming circuit 22 at predetermined timing. A variation absorbing buffer 21a of the reception buffer 21 adds a delay to the time between the reception of packets to the start of reproduction of the packets in order to ensure continuous reproduction even when the transmission delay time of the packets varies and the intervals of arrival of the packets vary. The streaming circuit 22 reconstructs packet data into stream reproduction data.

The CH1 decoding unit 13-1 and the CH2 decoding unit 13-2 are video/audio decoding devices formed by MPEG-4 decoders or the like.

A display controller 11d controls the combining unit 51-2 according to a screen change signal input from the remote control 60 to combine all or some of video data (CH1 video data) decoded by the CH1 decoding unit 13-1, video data (CH2 video data) decoded by the CH2 decoding unit 13-2, video data (own video data) input from the NTSC decoder 15, and video data (video content) input from the video buffer 80 and to output combined data (combined output) or, to output one of these video data without combining with other video data (through-output). The video data output from the combining unit 51-2 is converted to an NTSC signal at the video output unit 17 and output to the monitor 5.

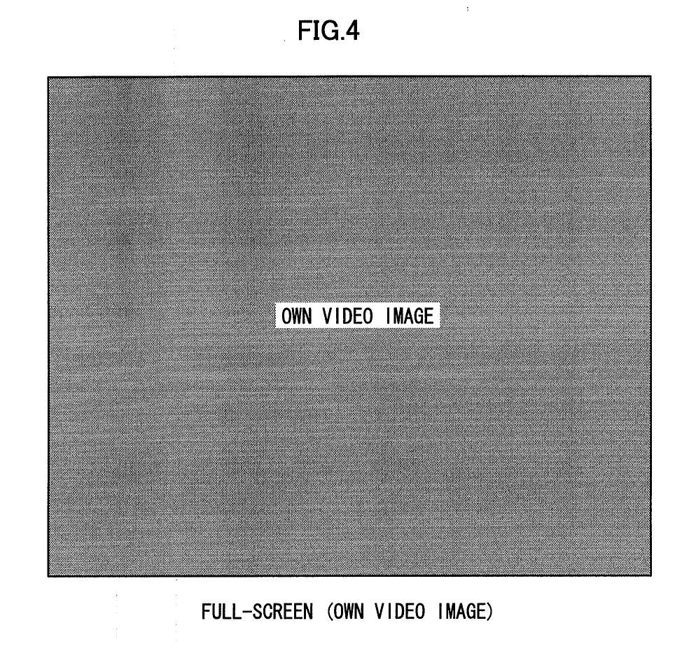

FIGS. 4 to 9 show exemplary screen displays on the monitor 5 on which combined video data is displayed. These screen displays are changed sequentially by a display mode selecting operation on the remote control 60.

FIG. 4 shows a screen display on the monitor 5 that is displayed when the combining unit 51-2 through-outputs only video data (own video image) provided from a camera 4 to the video output unit 17 without combining other video data. Here, only a video image (own video image) captured with the own camera 4 is displayed on the full screen.

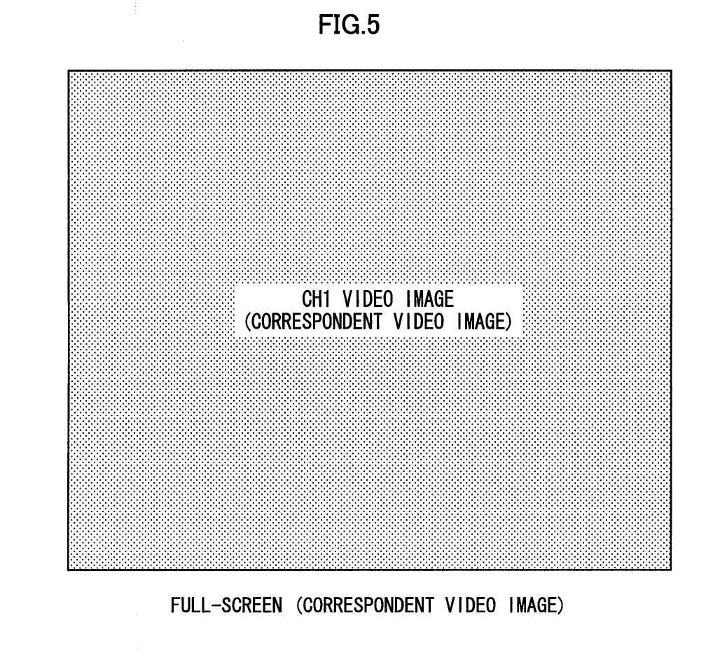

FIG. 5 shows a screen display on the monitor 5 that is displayed when the combining unit 51-2 through-outputs only video data (correspondent video image) from the CH1 decoding unit 13-1 to the video output unit 17 without combining with other video data. Here, only a video image (correspondent video image) captured by the correspondent's camera 4 is displayed on the full screen.

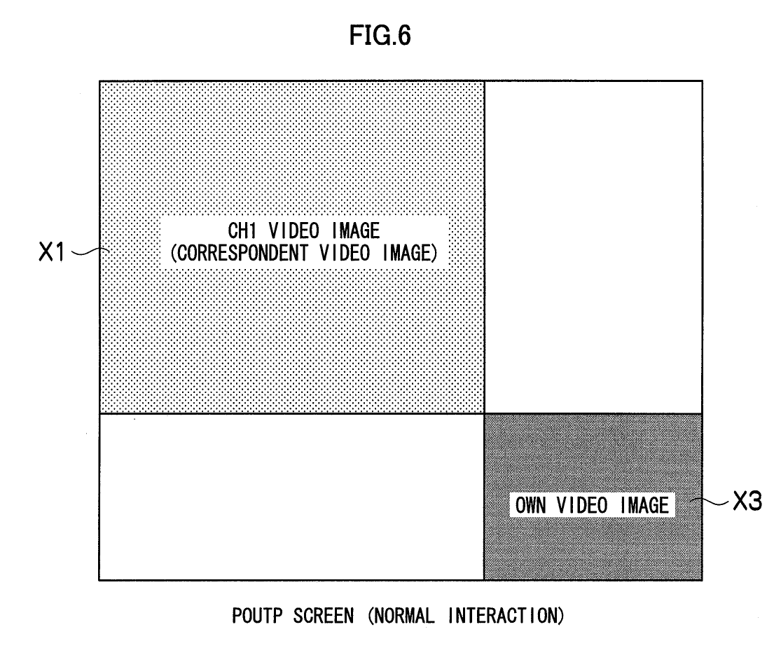

FIG. 6 shows a screen display on the monitor 5 that is displayed when the combining unit 51-2 combines video data (correspondent video image) from the CH1 decoding unit 13-1 with video data (own video image) from the own camera 4 and outputs the combined video data to the video output unit 17. Here, the correspondent video image and the own video image are displayed in display areas X1 and X3, respectively, on the screen.

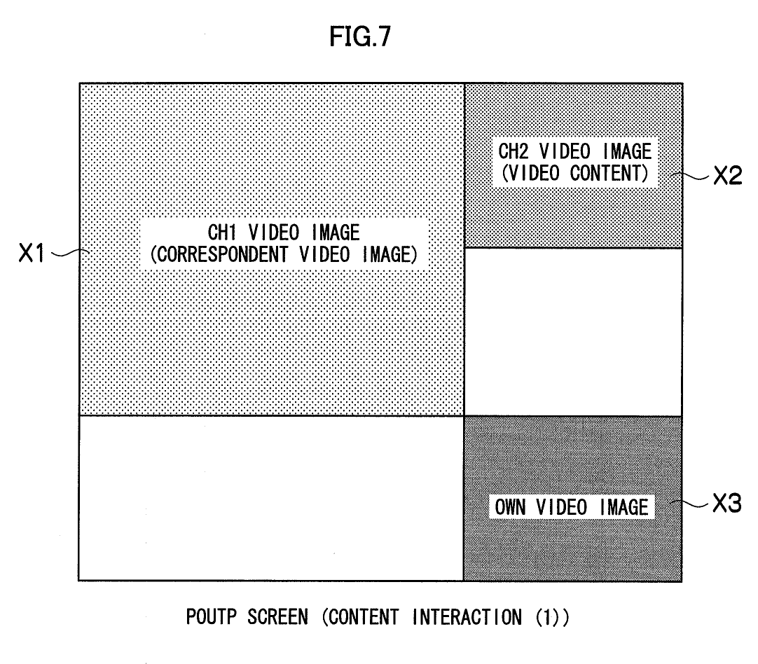

FIG. 7 shows a screen display on the monitor 5 that is displayed when the combining unit 51-2 combines video data (correspondent video image) from the CH1 decoding unit 13-1 with video data (video content) from the CH2 decoding unit 13-2 and video data (own video image) from the own camera 4 and outputs the combined data to the video output unit 17. Here, the correspondent video image is displayed in display area X1, the video content is displayed in display area X2, and the own video image is displayed in area X3, with being resized so as to fit in their respective display areas. A predetermined area ratio between X1 and X3 is maintained such that display area X1 is greater than display area X3.

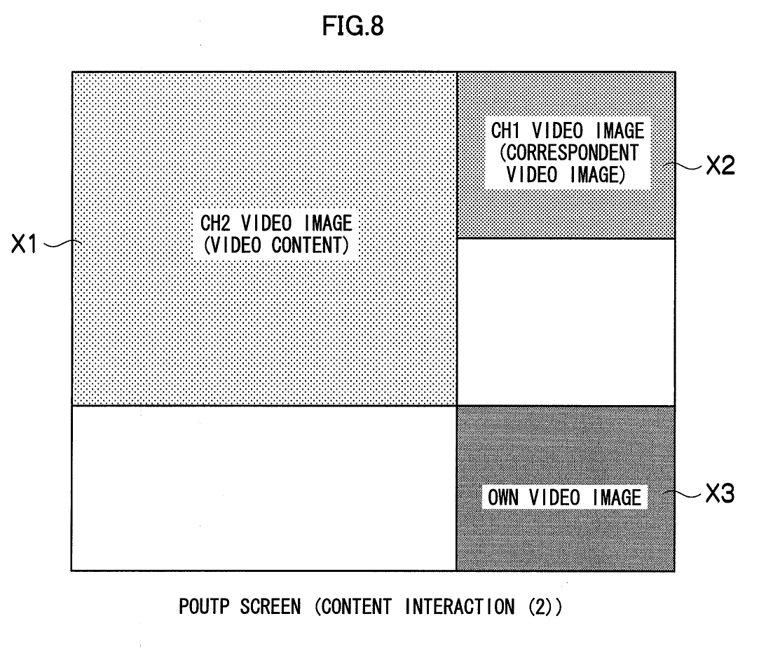

FIG. 8 shows a screen display on the monitor 5 that is displayed when the combining unit 51-2 combines video data (correspondent video image) from the CH1 decoding unit 13-1 with video data (video content) from the CH2 decoding unit 13-2 and video data (own video image) from the own camera 4 and outputs the combined video data to the video output unit 17. Here, the video content is displayed in display area X1, the correspondent video image is displayed in display area X2, and the own video image is displayed in display area X3.

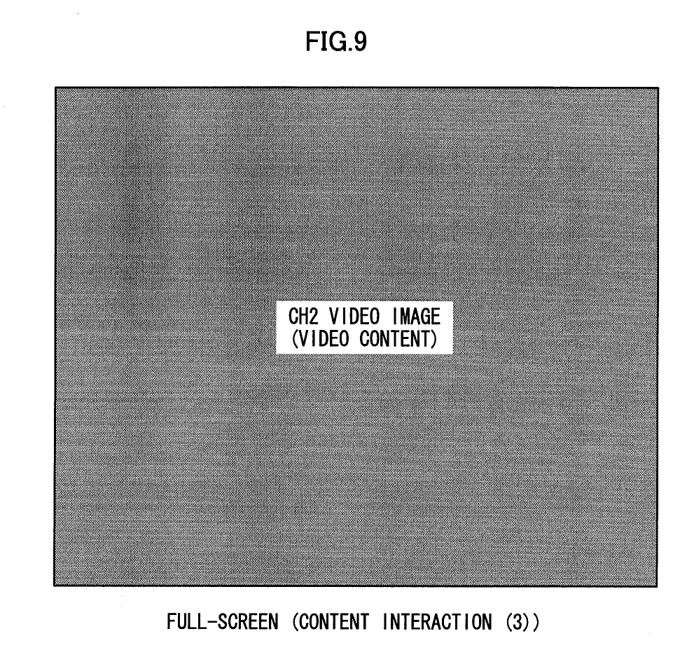

FIG. 9 is a screen display on the monitor 5 that is displayed when the combining unit 51-2 through-outputs only video data (video content) from the CH2 decoding unit 13-2 to the output unit 17 without combining with other video data. Here, only the video content is displayed.

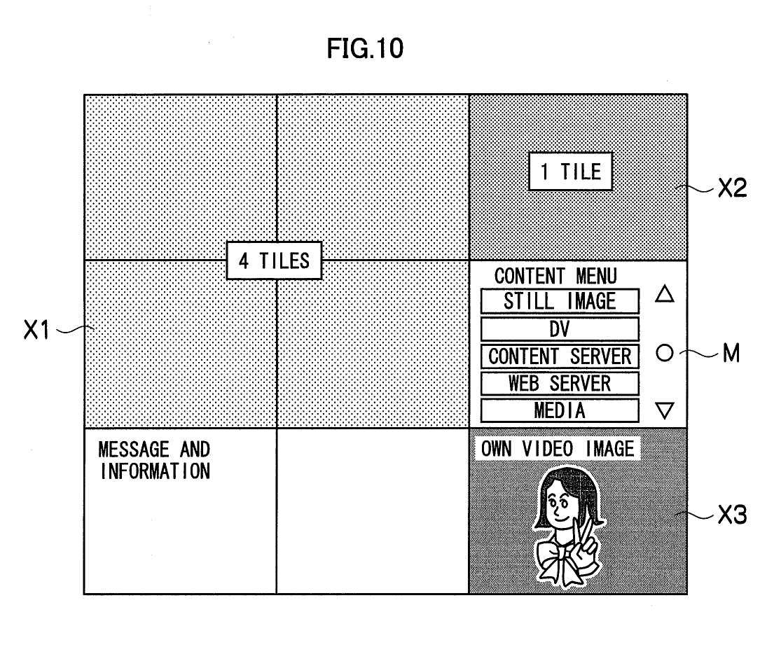

FIG. 10 shows an exemplary area ratio of display areas X1 to X3. Here, a screen with an aspect ratio of 4:3 is evenly split into 9 tiles. Display area X1 occupies 4 tiles and each of display areas X2 and X3 occupies one tile. The content menu display area M occupies 1 tile and the message and information display area occupies 2 tiles.

When a screen change signal is input from the remote control 60, communication terminal 1b sends a control packet indicating that the screen change signal has been input to communication terminal 1a through the network 10. The same function is included in communication terminal 1a as well.

A coding controller 11e allocates a transmission bandwidth to video images (which can be identified using by a control packet received from the correspondent communication terminal 1) displayed in display area X1, X2, and X3 on the monitor 5 of the correspondent communication terminal 1 within the range of an estimated transmission bandwidth at the area ratio of display areas X1, X2, and X3 that is identified by the control packet, and controls a quantization circuit 117 of the CH1 encoding unit 12-1 and the CH2 encoding unit 12-2.

Audio data decoded at the CH1 decoding unit 13-1 and CH2 decoding unit 13-2 are converted by the audio output unit 16 to analog audio signals and output to the speaker 2. If needed, audio data input from a source such as a digital video camcorder 70 and audio data included in content data can be combined at the combining unit 51-2 and output to the audio output unit 16.

A network terminal 61 is provided in the communication interface 13. The network terminal 61 is connected to a broadband router or an ADSL modem through any of various cables, thereby providing connection onto the network 10. One or more such network terminals 61 are provided.

Those skilled in the art have recognized that, when the communication interface 13 is connected to a router having a firewall and/or NAT (Network Address Translation, which performs translation between global IP addresses and private IP addresses) function, a problem arises that communication terminals 1 cannot directly be interconnected using SIP (so-called NAT traversal). In order to directly interconnect communication terminals 1 to minimize delay in video/audio transmission/reception, preferably a STUN technology using a STUN (Simple Traversal of UDP through NATs) server 30 or a NAT traversal function using a UPnP (Universal Plug and Play) server is included in the communication terminals 1.

The control unit 11 centrally controls the circuits in the communication terminal 1 on the basis of operation inputs from a user operation unit 18 or a remote control 60 including various buttons and keys. The control unit 11 is formed by a processing unit such as a CPU and implements the functions of a own display mode indicating unit 11a, a correspondent display mode detecting unit 11b, bandwidth estimating unit 11c, a display controller 11d, a coding controller 11e, and an operation identifying signal transmitting unit 11f in accordance with a program stored in a storage medium 23.

An address that uniquely identifies each communication terminal 1 (which is not necessarily synonymous with a global IP address), a password required by the account management server 8 to authenticate the communication terminal 1, and a boot program for the communication terminal 1 are stored in a non-volatile storage medium 23 capable of holding data even when not being powered. Programs stored in the storage medium 23 can be updated to the latest version by an update program provided from the account management server 8.

Data required for the control unit 11 to perform various kinds of processing is stored in a main memory 36 formed by a RAM which temporarily stores data.

Provided in the communication terminal 1 is a remote control photoreceiving circuit 63, to which a remote control photoreceiver 64 is connected. The remote control photoreceiving circuit 63 converts an infrared signal that entered the remote control photoreceiver 64 from the remote control 60 into a digital signal and outputs it to the control unit 11. The control unit 11 controls various operations in accordance with the digital infrared signal input from the remote control photoreceiving circuit 63.

A light emission control circuit 24 controls light emission, blinking, and lighting-up of an LED 65 provided on the exterior of the communication terminal 1 under the control of the control unit 11. A flash lamp 67 can also be connected to the light emission control circuit 24 through a connector 66. The light emission control circuit 24 also controls light emission, blinking, and lighting-up of the flash lamp 67. RTC 20 is a built-in clock.

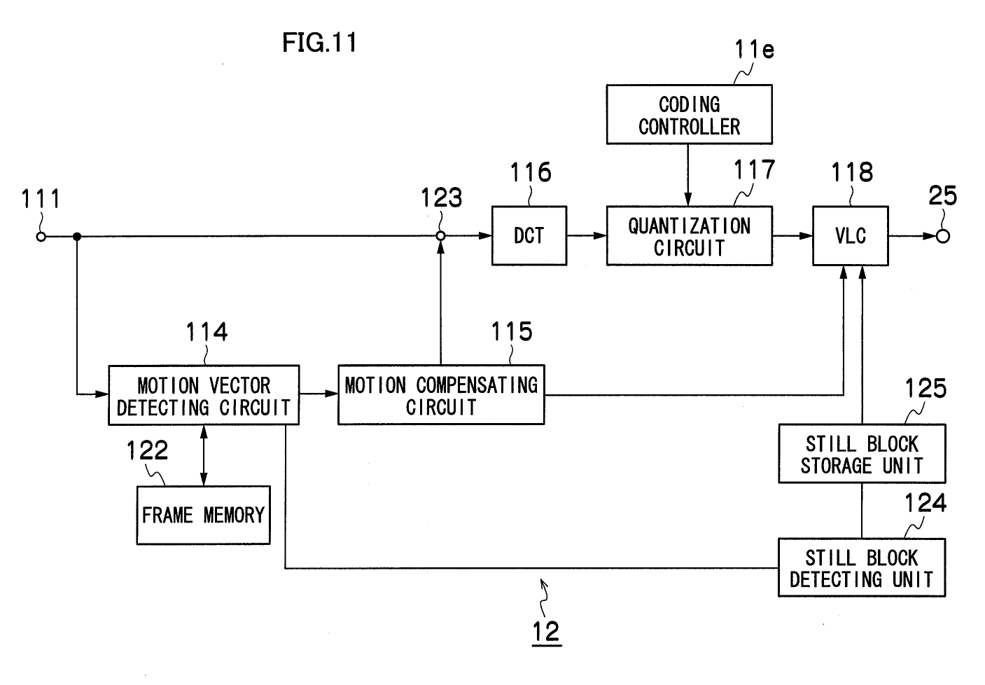

FIG. 11 is a block diagram showing a configuration of a substantial part common to the CH1 encoding unit 12-1 and the CH2 encoding unit 12-2. The CH1 encoding unit 12-1 and the CH2 encoding unit 12-2 (sometimes collectively referred to as the encoding unit 12) each includes an image input unit 111, a motion vector detecting circuit 114, a motion compensating circuit 115, a DCT 116, a quantization circuit 117, a variable-length coder (VLC) 118, a coding controller 11e, a still block detecting unit 124, a still block storage unit 125, and other components. The device includes part of a configuration of an MPEG video encoder that is a combination of motion compensated coding and compression coding based on DCT.

The image input unit 111 inputs a video image accumulated in the video capture buffer 54 or video buffer 80 (only a moving video image from a camera 4, only a moving video image or still image input from an input source such as a digital video camcorder 70, or moving video image consisting of a combination of those moving video and still images) in a frame memory 122.

The motion vector detecting circuit 114 compares the current frame image represented by data input from the image input unit 111 with the previous frame image stored in the frame memory 122 to detect a motion vector. For the motion vector detection, the image in the current input frame is divided into macro blocks, each macro block is used as a unit, and the macro block to be searched for is moved within a search area set on the previous image as appropriate while calculation of an error is repeated to find the macro block that is most similar to the macro block searched for (the macro block that has the smallest error). The shift distance between the found macro block and the macro block searched for and the direction of the shift are set as a motion vector. The motion vectors obtained for the individual macro blocks can be combined together by taking into consideration the errors of each macro block to obtain the motion vector that results in the smallest predictive difference in predictive coding.

The motion compensating circuit 115 performs motion compensation on a reference image for prediction on the basis of the detected motion vector to generate predicted image data and outputs the data to a subtractor 123. The subtractor 123 subtracts the predicted image represented by the data input from the motion compensating circuit 115 from the current frame image represented by the data input from the image input unit 111 to generate difference data representing a predicted difference.

Connected to the subtractor 123 are a DCT (Discrete Cosine Transform) unit 116, a quantization circuit 117, and a VLC 118, in this order. The DCT 116 orthogonal-transforms difference data input from the subtractor 123 for any block and outputs the result. The quantization circuit 117 quantizes orthogonal-transformed difference data input from the DCT 116 with a predetermined quantization step size and outputs the quantized difference data to the VLC 118. The VLC 118 is connected with the motion compensating circuit 115, from which motion vector data is input to the VLC 118.

The VLC 118 encodes the orthogonal-transformed and quantized difference data with two-dimensional Huffman coding, and also encodes the input motion vector data with Huffman coding, and combines them. The VLC 118 outputs variable-length coded moving video image data at a rate determined based on a coding bit rate output from the coding controller 11e. The variable-length-coded moving video image data is output to the packetizing unit 25 and packets are transmitted onto the network 10 as image compression information. The amount of coding (bit rate) of the quantization circuit 117 is controlled by the coding controller 11e.

Coded moving video image data generated by the VLC 118 has a layered data structure including a block layer, a macro-block layer, a slice layer, a picture layer, a GOP layer, and a sequence layer, in order from the bottom.

The block layer includes a DCT block, which is a unit for performing DCT. The macro-block layer includes multiple DCT blocks. The slice layer includes a header section and one or more macro blocks. The picture layer includes a header section and one or more slice layers. One picture corresponds to one screen. The GOP layer includes a header section, an I-picture which is a picture based on intraframe coding, and P- and B-pictures which are pictures based on predictive coding. The I-picture can be decoded by using only the information on itself. The P- and B-pictures require the preceding picture or preceding and succeeding pictures as predicted images and cannot be decoded by themselves.

At the beginning of each of the sequence layer, GOP layer, picture layer, slice layer, and macro-block layer, an identification code represented by a predetermined bit pattern is arranged. Following the identification, a header section containing a coding parameter for each layer is arranged.

The macro blocks included in the slice layer are a set of DCT blocks into which a screen (picture) is split in a grid pattern (for example 8×8 pixels). A slice consists of macro blocks connected in the horizontal direction, for example. Once the size of the screen is determined, the number of macro blocks per screen is uniquely determined.

In the MPEG format, the slice layer is a series of variable-length codes. A variable-length code series is a series in which a data boundary cannot be detected unless the variable-length codes are decoded. During decoding of an MPEG stream, the header section of the slice layer is detected and the start and end points of variable-length codes are found.

If all the image data input in the frame memory 122 is still images, the motion vectors of all macro blocks are zero and the data can be decoded by using only one picture. Accordingly, B- and P-pictures do not need to be transmitted. Therefore, the still images can be sent to a correspondent communication terminal 1 as a moving video image series with a relatively high definition even when the transmission bandwidth of the network 10 reduces.

Furthermore, even when the image data input in the frame memory 122 is a combined still and moving video image, the motion vectors of the macro blocks corresponding to the still image is zero and those macro blocks are treated as skipped macro blocks and the data in those blocks do not need to be transmitted.

When the image data input in the frame memory 122 consists of only still images, the frame rate may be reduced and the code mount of I-picture may be increased instead. This enables motionless still images to be displayed with a high definition.

Frame moving video images are sent to the correspondent communication terminal 1b in real time, in which the macro blocks correspond to a still image have a motion vector of 0 regardless of the type of the input source of the still image, even when the input source is changed by the switcher 78 of the own communication terminal 1a to the Web browser module 43, digital video camcorder 70, digital still camera 71, or media reader 74. Therefore, when the input source of a still image is changed at irregular intervals by the switcher 78 at the own communication terminal la, frame moving video images to be sent to the correspondent communication terminal 1 are quickly changed in response to the switching and consequently a still image to be displayed on the correspondent communication terminal 1b also changes.

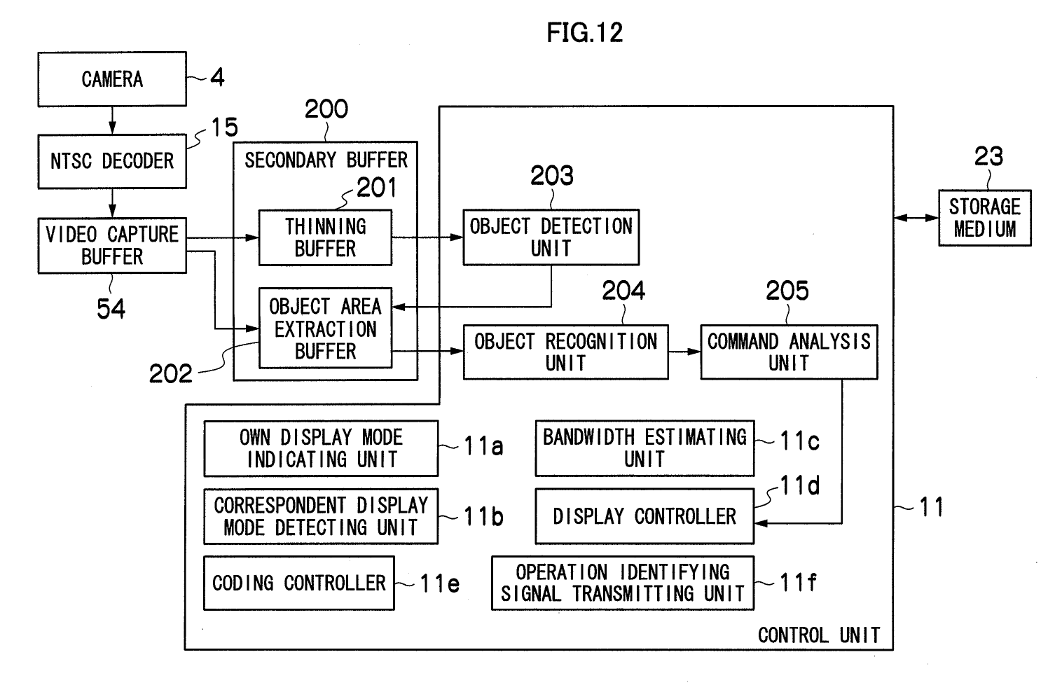

FIG. 12 shows functional block of the control unit 11 and substantial blocks around the control unit 11. As mentioned earlier, the control unit 11 implements the functions of the own display mode indicating unit 11a, correspondent display mode detecting unit 11b, bandwidth estimating unit 11c, display controller 11d, coding controller 11e, and operation identifying signal transmitting unit 11f in accordance with a program stored in a storage medium 23.

The control unit 11 also includes an object detection unit 203, an object recognition unit 204, and a command analysis unit 205. These functions are implemented in accordance with the program stored in the storage medium 23.

Image data in the video capture buffer 54 is sent to a secondary buffer 200, and is then provided to the control unit 11. The secondary buffer 200 includes a thinning buffer 201 and an object area extraction buffer 202.

The thinning buffer 201 thins frame images provided from the video capture buffer 54 and outputs the resulting images to the object detection unit 203. For example, when frame images of a size of 1280×960 pixels are sequentially output from a camera 4 to the video capture buffer 54 at 30 fps (frames per second), the size of the frame images is thinned to ⅛.

The object detection unit 203 is connected to the thinning buffer 201 and detects a candidate image portion of thinned images where a particular object is performing a particular motion (candidate motion area). The object may be a part of a human body such as a hand or an inanimate object such as a stick of a particular shape. Examples of a particular motion, which will be detailed later, include a dynamic motion that changes periodically over several frames, such as wagging an index finger, and a static motion that is substantially unchanged over a several frames, such as keeping the thumb and index finger touched together to form a ring or keeping all or some of the thumb and fingers extended.

The first motion to be recognized while a particular object is being tracked is referred to as a first preliminary motion.

When the object detection unit 203 detects a candidate motion area, the object detection unit 203 indicates the position of the candidate motion area to the object area extraction buffer 202.

The object area extraction buffer 202 extracts an area corresponding to the position of the indicated candidate motion area from the video capture buffer 54. The object recognition unit 204 recognizes an image portion (motion area) of that area where a particular object is making a particular motion. Because the candidate motion area extracted from the video capture buffer 54 has not been thinned, the accuracy of recognition of the motion area is high.

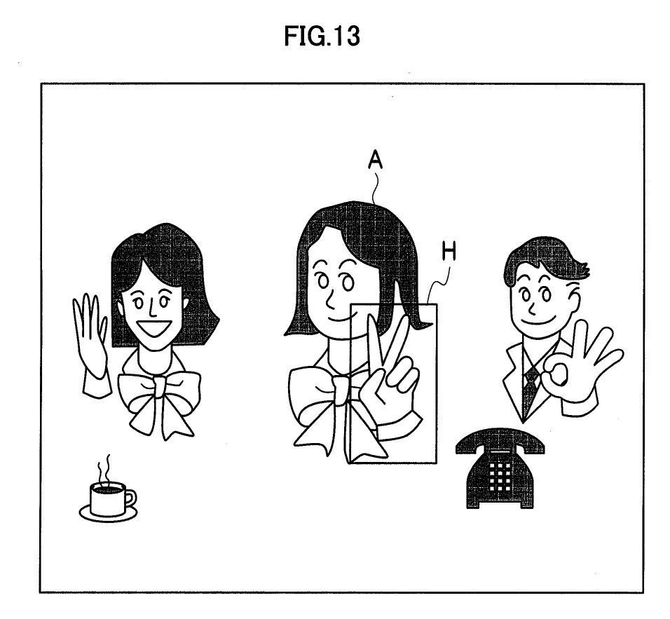

For example, suppose only a particular person A among three people are wagging the left index finger as shown in FIG. 13. The object detection unit 203 detects the wagging motion of the finger as a first preliminary motion of a particular object. In particular, the wagging motion is a motion in which the finger moves to and fro in about 0.5 to 2 seconds and the object detection unit 203 calculates the difference between the thinned frame images. The difference between the frames represents only the image area that is moving. The object detection unit 203 picks up the image area portion that is periodically moving to and fro from the trajectory of the difference and detects that portion as a candidate motion area. The portion in box H in FIG. 13 is a candidate motion area. More than one candidate motion area can be detected. For example, although not shown, a curtain periodically stirring in the breeze can be detected as a candidate motion area.

The address of the location of the candidate motion area H in FIG. 13 is indicated by the object detection unit 203 to the object area extraction buffer 202 and the motion of the object is analyzed in further detail from the portion of the frame image that corresponds to the location address of the candidate motion area H.

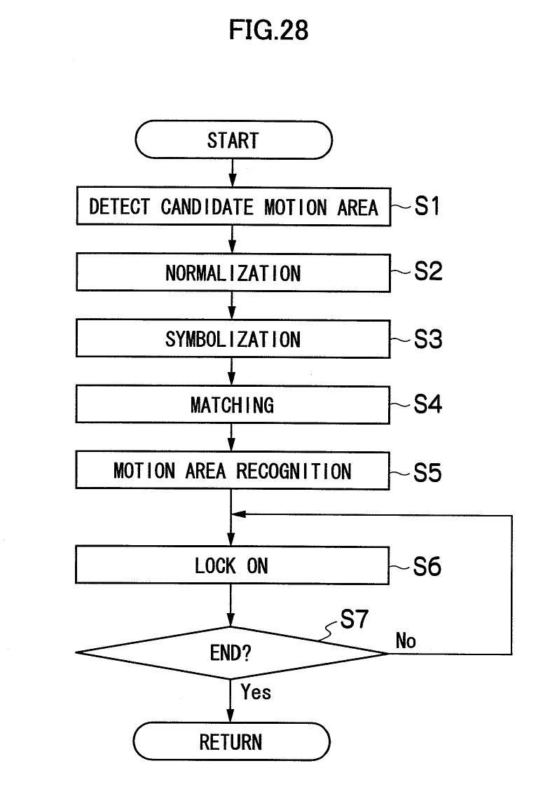

FIG. 28 shows a flow of a motion area recognition process. When a candidate motion area is detected (S1), the object recognition unit 205 extracts an image area corresponding to the location address of the detected candidate motion area H from an image in the object area extraction buffer 202 and reduces or enlarges the image area so that the image area matches the size of a reference image of several frames that correspond to an index finger wagging motion (first preliminary motion) stored in a storage medium 23 beforehand (normalization at S2). Then, the normalized candidate motion area is transformed into a monochrome or gray-scale image, or binarized or filtered to simplify the shape of the object in the candidate motion area (symbolization at S3).

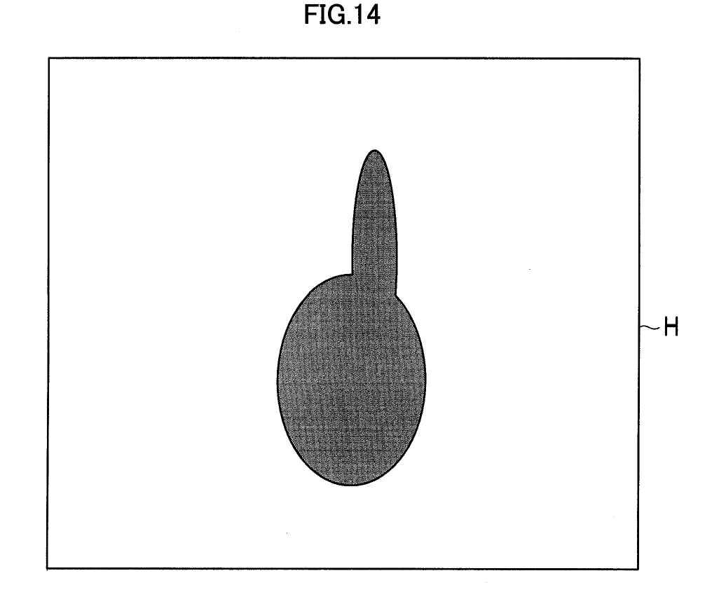

Then, the correlation between the shape of the object in each candidate motion area symbolized as shown in FIG. 14 and the reference image is analyzed (matching at S4). If the correlation exceeds a predetermined lower threshold, the motion area candidate is recognized as a motion area corresponding to the index finger wagging motion (S5).

The object recognition unit 205 subsequently keeps track of the recognized motion area in the frame images provided from the object area 202 (lock on at S6). As a result, a motion operation mode is set and a process for recognizing a second preliminary motion, which will be described later, is started.

Lock-on continues until an end command is issued or the motion area becomes unable to be tracked for some reason (S7). After the lock-on ends, the process returns to S1, where the object recognition unit 205 waits for the first preliminary motion.

In a specific implementation of lock-on, for example a parameter (feature information) indicating a feature such as color information is obtained from the recognized motion area and the area where the feature information is found is tracked. As one specific example, suppose a person wearing red gloves is wagging the index finger. First, the shape of symbolized finger in a candidate area is matched with a reference image to recognize the motion area and feature information “red color” is extracted from the motion area. Once extracted, the motion area is locked on by recognizing the feature information.

That is, once a motion area is recognized and feature information is extracted, the only thing to do is to lock on the feature information, regardless of whatever shape the hand will take. Accordingly, the load of the processing is light. For example, even when the hand is open or closed, the color information “red” is continued to be tracked as long as the person is wearing the red gloves.

The two-step recognition including detection of candidate motion areas in thinned images and recognition of a motion area in the candidate motion areas as described above can increase the rate of recognition of a desired motion area and reduce the load on the control unit 11, as compared with recognition only by detecting a particular color such as a skin color. Furthermore, detection of a candidate motion area and recognition of the motion area do not need to be repeated for all frame images and therefore the load on the control unit 11 is reduced. Simpler feature information further reduces the load on the control unit 11.

After the lock-on is completed, the object recognition unit 205 sets a motion operation mode and waits for input of a second preliminary motion from the motion area it recognized.

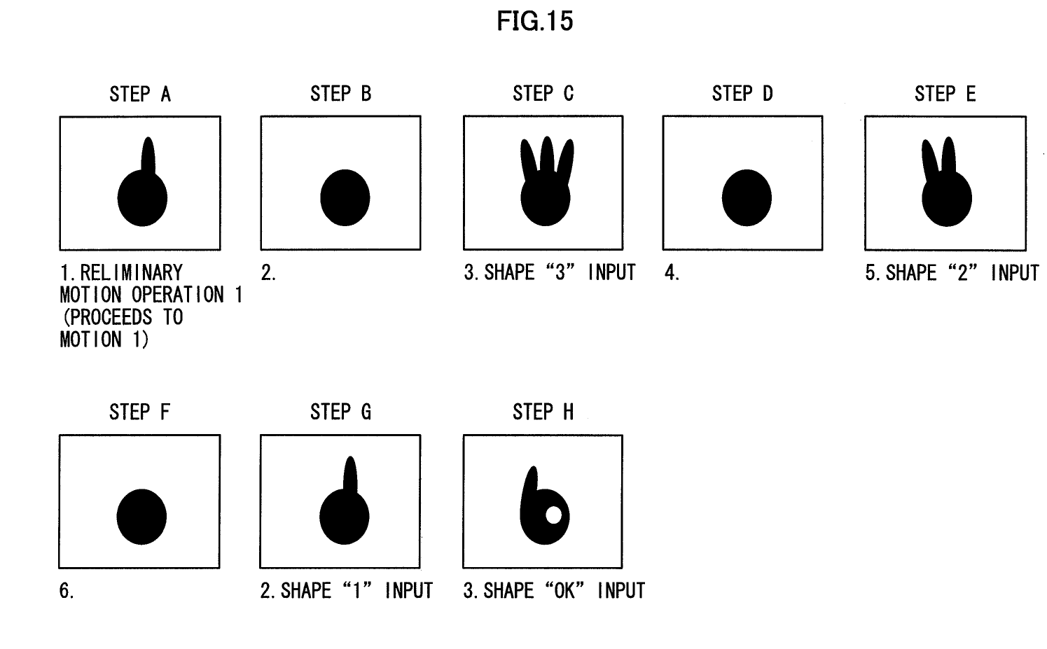

FIG. 15 shows a first preliminary motion which is “wagging of the index finger” (STEP A), and second preliminary motions, which are a “motion indicating 3 by fingers” (STEP C), a “motion indicating 2 by fingers” (STEP E), a “motion indicating 1 by a finger” (STEP G) and a “motion indicating OK by fingers” (STEP H). A dictionary in which handshape models sampled and normalized beforehand are registered as reference images for second preliminary motions is stored in the storage medium 23.

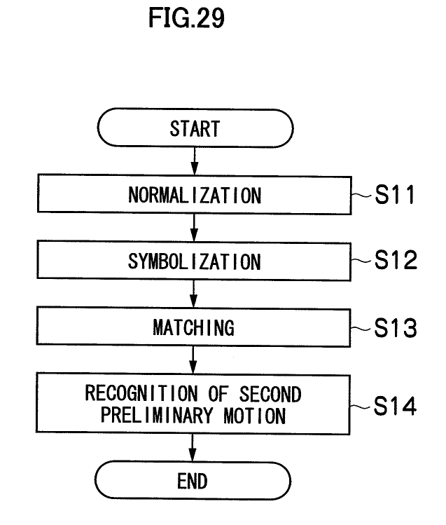

FIG. 29 shows a flow of a process for recognizing a second preliminary motion. First a motion area to be tracked as described above is normalized so as to match the size of a reference image (S11). The normalized motion area is symbolized by applying noise reduction with filtering and binarization (S12) to facilitate matching with the reference image of the second preliminary motion.

Then, the degree of matching between them is determined on the basis of the correlation rate of the symbolized motion area and the shape model in the dictionary (S13). In order to increase the accuracy of the determination, the candidate motion area may be transformed into a gray-scale representation instead of binarizing the candidate motion area.

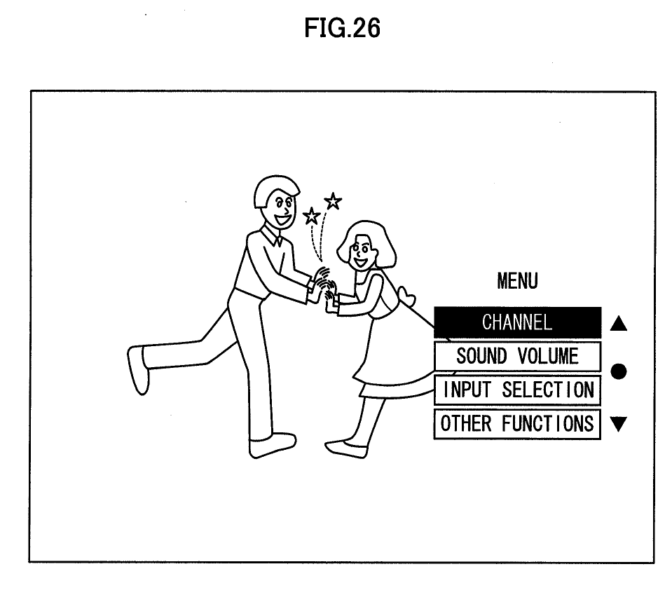

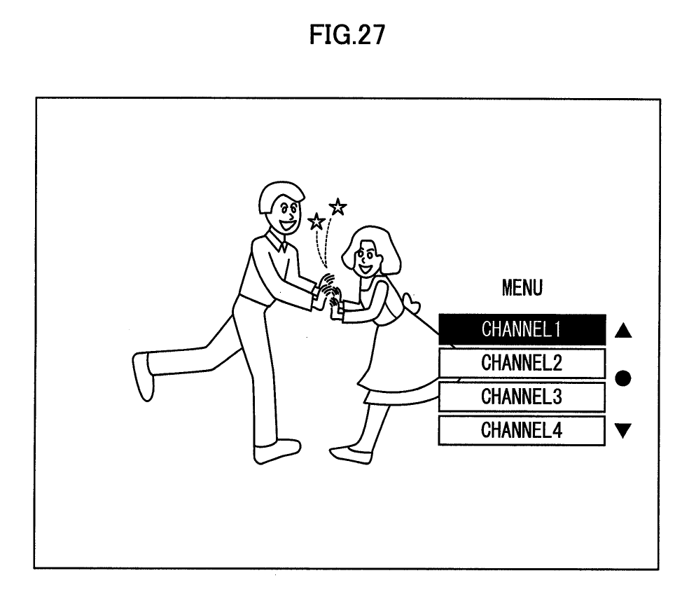

If the degree of matching exceeds a predetermined lower threshold, it is determined that the second preliminary motion has been recognized and operation control according to the second preliminary motion is initiated. The operation control according to the second preliminary motion may be switching to a communication screen (FIGS. 3 to 10) or a television receiving screen (FIGS. 26 and 27). An identification number, for example “3”, “2”, “1” included in the second preliminary motion determines which screen is to be displayed.

Once recognizing the second preliminary motion, the object recognition unit 205 recognizes various control command motions in the motion area locked on. The command motion may be to move an index finger (or wrist) in a circular motion, which may correspond to an operation of turning a jog dial to instruct to select a menu item. The motion is recognized as follows.

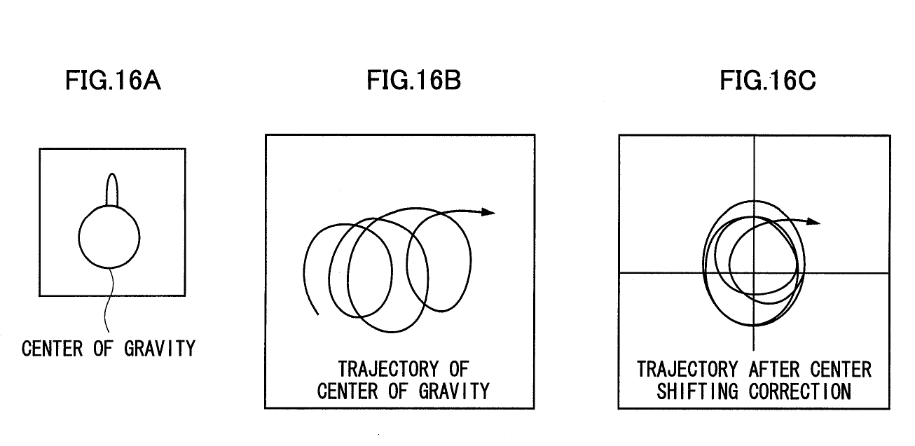

As shown in FIG. 16A, an observation point, for example the center of gravity of a particular shape recognized is determined. The recognized shape of object is considered as a two-dimensional plane and the center of gravity of the shape is mathematically obtained. Then, the trajectory of the center of gravity is obtained as shown in FIG. 16B. Whether the center of gravity is rotating clockwise or counterclockwise is determined, and the angle of the rotation is determined. The results are output to the display controller 11d. Preferably, correction is made to align rotation centers of loops as shown in FIG. 16C so that the direction and angle of the rotation can be accurately detected.

The observation point is not limited to the center of gravity of an object. For example, if a particular object recognized is a stick, the tip of the stick may be chosen as the observation point.

When the object recognition unit 205 recognizes an end motion or after the object recognition unit 205 has recognized no input for a specified period of time, the object recognition unit 205 cancels the lock-on of the motion area and exits the motion operation mode (S7 of FIG. 28). Then, the object detection unit 203 restarts detection of a candidate motion area.

The motion instruct to exit the motion operation mode may be to wave an open hand (wave goodbye). In order to recognize this motion, the number of extended fingers may be counted exactly, or the hand shape may be recognized to find that more than two fingers are extended and then the movement of the hand may be tracked for about 0.5 to 2 seconds and, when it is recognized that the hand is moving to and fro, it is considered that “waving goodbye” motion is being made.

The following is a description of a first preliminary motion, second preliminary motion, control command motion, and end command motion recognized on a communication terminal 1 and a specific implementation of display control of GUI (Graphical User Interface) according to these motions.

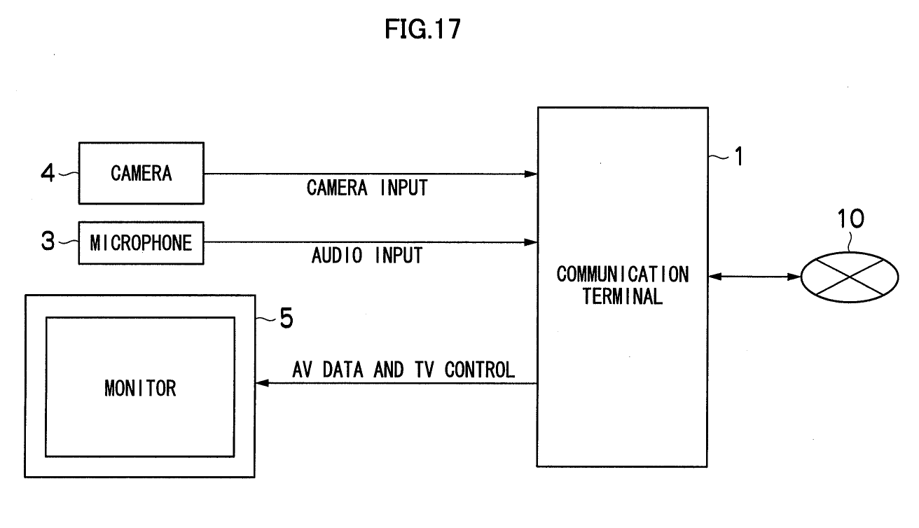

FIG. 17 shows connections between the communication terminal 1 and a monitor 5, microphone 3, and camera 4. Video data from the camera 4, audio data from the microphone 3, and video and audio data from a network 10 are provided to the communication terminal 1. The video and audio data are converted to digital data and interface-converted in the communication terminal 1 as needed, and then input to an AV data input terminal of a monitor 5.

The AV data input terminal of the monitor 5 also functions as an input terminal for inputting a TV control signal from the communication terminal 1. The communication terminal 1 multiplexes digital data packets of the video and audio data with digital data packets of the TV control signal and inputs the combined packets to the AV data input terminal of the monitor 5. If the video and audio do not need to be reproduced on the monitor 5, AV packets are not sent. If a high-quality video image is to be transmitted, the video signal and the TV control signal may be transmitted through separate signal lines without multiplexing.

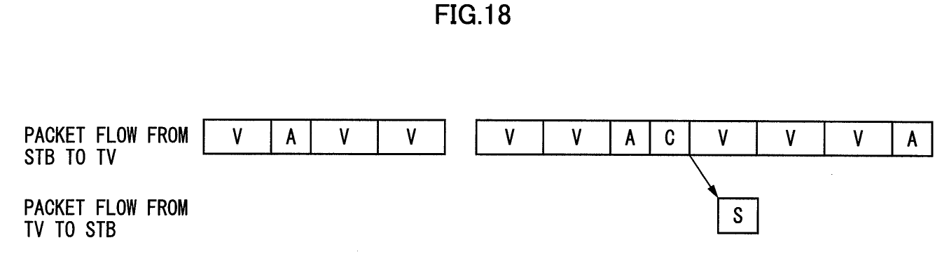

FIG. 18 schematically shows a flow of packets input from the communication terminal 1 to the AV data input terminal of the monitor 5. In FIG. 18, V denotes video signal packets, A denotes audio signal packets, C denotes a TV control signal packet, and S denotes a status packet.

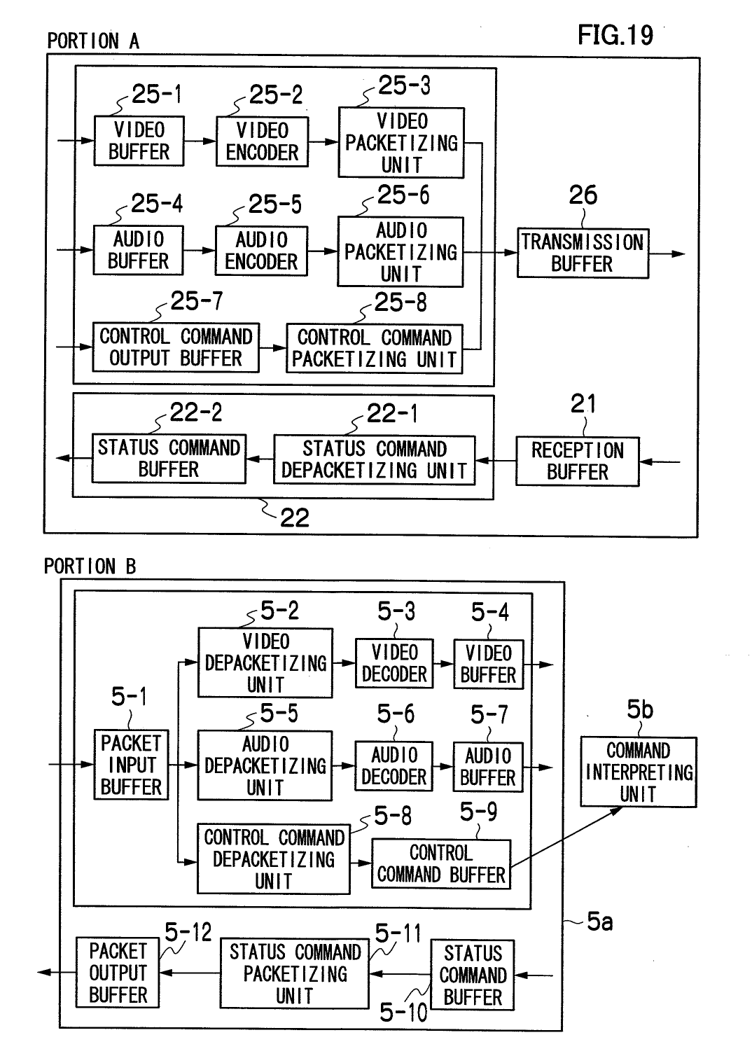

The video packets are generated by a video buffer 25-1, a video encoder 25-2, and a video packetizing unit 25-3 included in the packetizing unit 25 as shown in FIG. 19 (portion A). The video packets are generated by packetizing a digital signal resulting from encoding of a video image such as MPEG-2 or H.264, for example.

The audio packets are generated by an audio buffer 25-4, an audio encoder 25-5, and an audio packetizing unit 25-6. Like the video packets, the audio packets are generated by packetizing a signal resulting from encoding audio.

Also embedded in these packets are data used for synchronizing audio and video so that audio and video are reproduced on the monitor 5 in synchronization with each other.

A control packet is inserted between a video packet and an audio packet. The control packet is generated by a control command output buffer 25-7 and a control command packetizing unit 25-8.

The transmission buffer 26 combines video packets, audio packets, and control packets as shown in FIG. 18 and outputs the resulting packet data to an external input terminal of the monitor 5.

When packet data is received at the monitor 5, they are temporarily stored in a packet input buffer 5-1, and then is separated into video, audio, and control packets and input into a video depacketizing unit 5-2, an audio depacketizing unit 5-5, and control command depacketizing unit 5-8 as shown in FIG. 19 (portion B).

The video packets input in the video depacketizing unit 5-2 are decoded by a video decoder 5-3 into a video signal and stored in a video buffer 5-4.

The audio packets input in the audio depacketizing unit 5-5 are decoded by an audio decoder 5-6 into an audio signal and stored in an audio buffer 5-7.

The video signal and the audio signal stored in the video buffer 5-4 and the audio buffer 5-7 are output to the display screen of the monitor 5 and the speaker in synchronization with each other as appropriate.

The control packets are converted by the control command depacketizing unit 5-8 into a control signal and temporarily stored in a control command buffer 5-9, then is output to a command interpreting unit 5b.

The command interpreting unit 5b interprets an operation corresponding to the TV control signal and instructs components of the monitor to perform the operation.

A status signal indicating the status of the monitor 5 (such as the current television channel received and the current destination of an AV signal) is stored in a status command buffer 5-10 as needed and then packetized by a status command packetizing unit 5-11. The packets are stored in a packet output buffer 5-12 and are sequentially transmitted to the communication terminal 1.

Upon reception of the packets of the status command, the communication terminal 1 temporarily stores the packets in a reception buffer 21. The packets are then converted at a status command depacketizing unit 22-1 to a status signal and the status signal is stored in a status command buffer 22-2. The control unit 11 interprets the status command stored in the status command buffer and thereby can know the current status of the monitor 5 and can proceed to the next control.

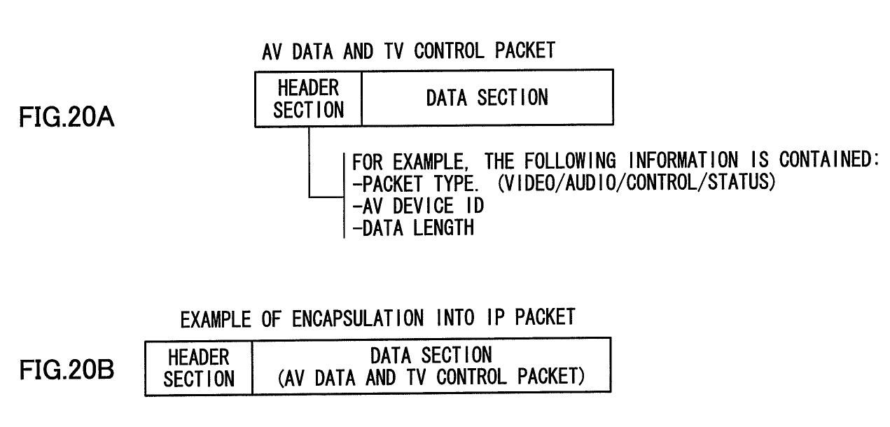

Packet data includes a header section and a data section as shown in FIG. 20A. Information in the header section indicates the type and data length of the packet so that the body data can be taken out of the data section. While one monitor 5 is connected to one communication terminal 1 in FIG. 19, other AV devices can be connected to the communication terminal 1 in addition to the monitor 5. If the communication terminal 1 is controlled together with such AV devices, a device ID is added to the header section so that AV data and control data can be directed to an appropriate AV device. In other words, devices that can be controlled by the communication terminal 1 is not limited to the monitor 5.

A path through which the control signal and status command are sent and received is not limited to specific one. A control signal or status command encapsulated in the body of an IP packet as shown in FIG. 20B may be transmitted through a LAN.

A specific example of operation through the communication terminal 1 will be given below.

The object recognition unit 204 locks on a motion area and then the command analysis unit 205 recognized a first preliminary motion in the motion area locked on as described earlier. It is assumed here that the first preliminary motion is wagging of an index finger (FIG. 15, STEP A).

When the command analysis unit 205 recognizes the first preliminary motion, the command analysis unit 205 instructs a light emission controller 24 to blink a flash lamp 67 for a predetermined time period. In response to the command, the flash lamp 67 blinks for the predetermined time period.

On the other hand, the display controller 11d, in response to the command analysis unit 205 recognizing the first preliminary motion, sends a command to turn on the main power supply to the monitor 5 in a standby state as a TV control signal packet. Upon reception of the packet, the monitor 5 converts it into a TV control signal and recognizes the information, the command to turn on the main power supply, and turns on the main power supply.

Then, the command analysis unit 205 recognizes a second preliminary motion in the motion area locked on. There are two or more types of second preliminary motions. A first one is a preliminary motion that instructs to go to an operation menu relating to video/audio communication between communication terminals 1; second one is a preliminary motion that instructs to go to an operation menu relating to reproduction of video/audio input from a television receiver or AV devices.

When the command analysis unit 205 recognizes a motion of sequentially lifting fingers to indicate three-digit number (like “3”, “2” and “1”) representing a communication mode as shown in FIGS. 15C to 15H, then recognizes a motion indicating “OK”, the command analysis unit 205 interprets the motion sequence as an intentional second preliminary motion instructing to go to the operation menu relating to video/audio communication between communication terminals 1.

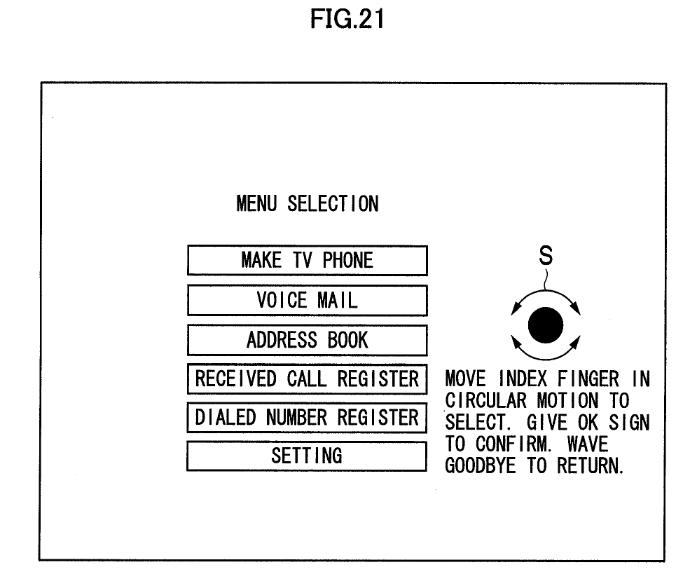

In this case, the display controller 11d generates a video image of a communication terminal operation menu (see FIG. 21) and sends a packet in which a TV control signal instructing to change the video input source to the communication terminal 1 is combined with the video image to the monitor 5. Upon receiving the packet, the monitor 5 converts the packet to a TV control signal and change the video input source to the communication terminal 1, and then displays the communication terminal operation menu screen provided from the communication terminal 1. The video input source can be changed to the communication terminal 1 by an operation on a remote control 60 as well without relying on the TV control signal.

While motions of a left hand are shown in FIG. 15, the command analysis unit 205 can recognize motions of a right hand as well, of course. The command analysis unit 205 may receive a setting for recognizing only right hand or left hand motions to suit preferences of a user and may switch the reference image for a motion area between left and right hand versions.

Before the communication terminal operation menu screen is provided, a video image corresponding to a default input signal to the monitor 5 (such as a television broadcast signal) and a standard menu screen that can respond to manual operations on the remote control 60 may be displayed.

On the other hand, upon recognizing a motion that instructs to go to a predetermined television operation menu screen as a second preliminary motion, the command analysis unit 205 instructs the monitor 5 to display the television operation menu screen image (see FIG. 26). In the second preliminary motion, a user extends fingers sequentially to indicates a three-digit number indicating that the input source of video or audio is a television signal and then indicates “OK”. For example, the user indicates “2”, “5”, “1”, and “OK”.

In the television operation menu screen, a menu screen generated by the monitor 5 itself is superimposed on a television screen. This screen control is instructed using a TV control signal.

After recognizing the second preliminary motion, the command analysis unit 205 recognizes a motion in the locked-on motion area that instructs to select a menu item.

Provided in the communication terminal operation menu screen shown in FIG. 21 are menu items such as “Make TV phone”, “Voice mail”, “Address book”, “Received call register”, “Dialed number register”, and “Setting”. Any one of the items can be selected by moving an index finger (or wrist) in a circular motion. Near the menu items, an operation command mark S is displayed that indicates that a menu item can be selected by a hand motion.

If the motion area can no longer be tracked because the object that is recognized as a motion area is off the view angle of a camera 4 or the motion of the object is too fast, or the object is hidden by another object, the operation command mark S is grayed out to indicate that the motion area cannot be tracked. After the motion area cannot be tracked for a predetermined period of time, the operation indication mark S is dismissed from the screen and the motion operation modes is exited.

When the command analysis unit 205 recognizes the trajectory of a clockwise rotational motion in the motion area, the display controller 11d highlights the menu items one by one in order from the top to bottom. When the command analysis unit 205 recognizes the trajectory of a counterclockwise rotational motion in the motion area, the display controller 11d highlights the menu items one by one in order from the bottom to top.

This allows the user to select menu items one by one in order from the top to bottom or from bottom to top by moving an index finger (or wrist) in a circular motion and also allows the user to readily know which of the menu items is currently selected from the movement of the highlight.

The unit of the command motion required for changing the menu item to select is not necessarily a 360-degree rotation. For example, the highlight may be shifted to the next item each time the user rotates an index finger (or wrist) by 180 degrees. The menu items may be highlighted in order from top to bottom by a counterclockwise rotation, and bottom to top by a clockwise rotation.

Upon recognizing a motion command indicating “OK”, the command analysis unit 205 activates the function corresponding to the currently highlighted menu item. For example, when “OK” is recognized while the item “Address book” is highlighted, an address book screen is displayed on which address book information can be seen, updated, added and modified, and settings can be made for rejecting or accepting a call from each of the contacts registered in the address book information.

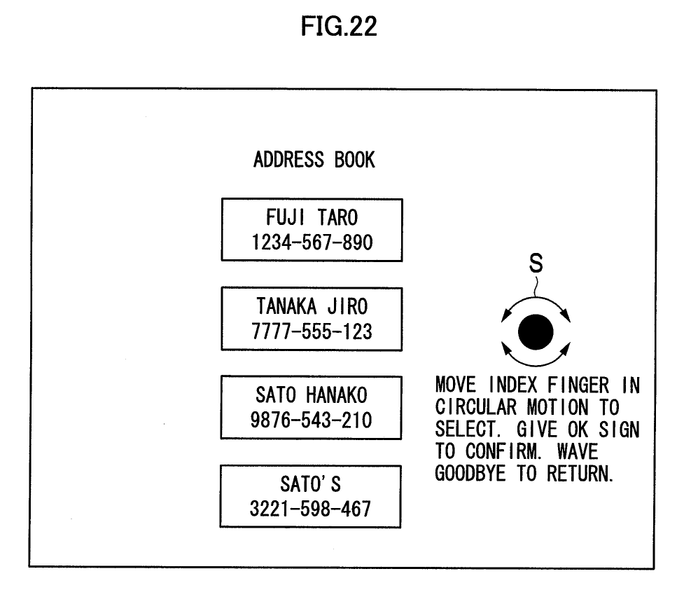

In the address book screen shown in FIG. 22, a desired contact can be selected and entered by a rotational motion and an OK motion of a hand. When a desired contact is entered on the screen, a send screen appears.

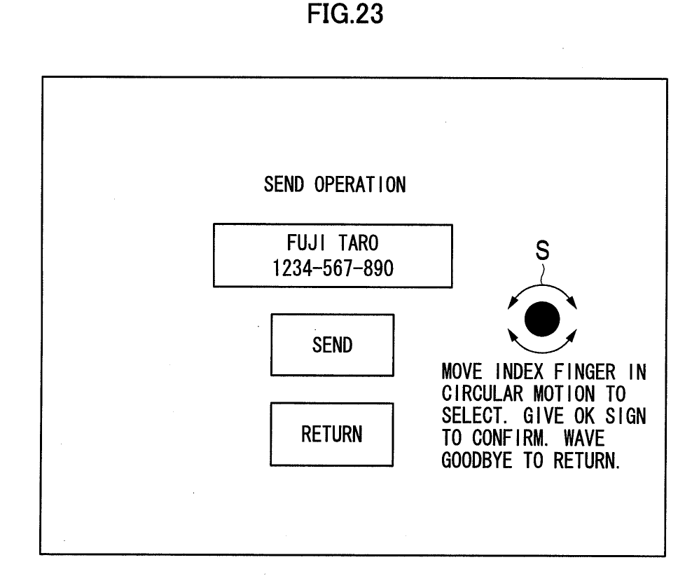

The items “Send” and “Return” are contained in the send screen shown in FIG. 23 and one of which can be selected by a rotational motion and an OK motion of a hand. When the OK motion is recognized while the item “Send” is selected, a connection request is sent to the communication terminal 1 at the contact address selected on the address book screen.

When a connection request (call) is permitted by the communication terminal 1 at the contact, a transmission operation screen appears.

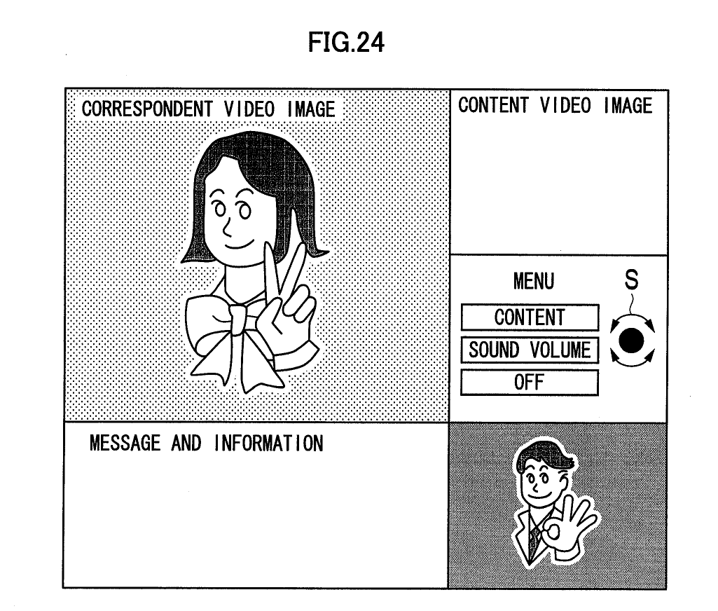

In the transmission operation screen shown in FIG. 24, there are displayed a correspondent video image, an own video image, and menu items such as “Content”, “Sound volume”, and “Off” are displayed. On the screen, a desired menu item can be selected and entered by a rotational motion and an OK motion of a hand.

A body motion during a conversation can be mistakenly recognized as a rotational motion. The user can avoid this by making a “goodbye” motion of waving a hand to cancel the lock-on of the motion area and exit the motion operation mode. The operation indication mark S disappears from the screen and an LED 65 blinks to indicate that the motion operation mode has ended.

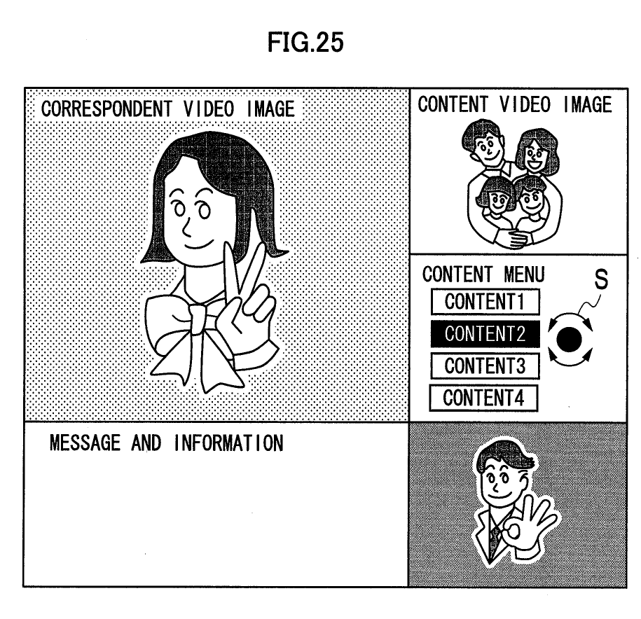

When the item “Content” is selected on the transmission operation screen in FIG. 24 and an OK motion is recognized, a video content selection menu items appear as shown in FIG. 25. When a desired content is selected from the menu by a rotational motion and an OK motion of a hand, the selected content is displayed. “Content 2” is displayed in FIG. 25 because the menu item “Content 2” has been selected.

In addition, menu items for accepting a connection request from a correspondent, adjusting the sound volume of an incoming call, and disconnecting a call may be provided so that they can be elected by a rotational motion and an OK motion of a hand.

After the motion operation mode is exited because a “goodbye” motion is recognized or a predetermined time period has elapsed after a motion area became untraceable, if a user wants to display the menu items again, the user performs the first preliminary motion described above. Upon recognizing the first preliminary motion, the control unit 11 may immediately provide the video image of the menu items without recognition of a second preliminary motion because communication with the correspondent has been already established in this case.

On the other hand, menu items such as “Channel”, “Sound volume”, “Input selection”, and “Other functions” are displayed on a television operation menu screen (FIG. 26). On this screen, a desired menu item can be selected and entered by making a rotational motion and an OK motion of a hand.

When the item “Channel” is selected and entered, a command to superimpose a channel selection submenu on a television screen is sent from the communication terminal 1 to the monitor 5 (FIG. 27).

In the channel selection submenu, channel numbers such as “Channel 1”, “Channel 2”, “Channel 3”, and “Channel 4” are displayed as items. Also on the screen, a desired channel number can be selected and entered by a rotational motion and an OK motion of a hand. The selected channel number is sent from the communication terminal 1 to the monitor 5 as a TV control signal and the monitor 5 tunes to the channel associated with the channel number.

The currently selected channel is reflected in the menu items as follows. When the item “Channel” is selected on the television operation menu, the communication terminal 1 first sends a “COMMAND GET CHANNEL” command to the monitor 5. The command is a command that requests an indication of the currently tuned channel number.

In response to this command, the monitor 5 returns the number of the currently tuned channel to the communication terminal 1 as a status packet. For example, when the monitor 5 is tuned to “channel 1”, the monitor returns “STATUS CHANNEL No. 1”.

The communication terminal 1 reflects the channel number it received from the monitor 5 in the channel selection menu. For example, when “STATUS CHANNEL No. 1” is returned, the communication terminal 1 instructs the monitor 5 to highlight the item “Channel 1”. In response to the command, the monitor 5 highlights only that item among the menu items superimposed on a television picture.

When the user moves a hand in a circular motion to select a channel, a command to change the channel item to highlight according to the rotation of the hand is sent from the communication terminal 1 to the monitor 5. Each time such a command is sent, a cannel selection operation corresponding to the selected channel item is displayed on the monitor 5. As has been described above, if a clockwise rotational motion is made, “COMMAND CHANNEL UP”, which is a command to select channel numbers one by one in order from bottom to top, is sent from the communication terminal 1 to the monitor 5 each time a predetermined rotation angle of the clockwise rotational motion is detected. If a counterclockwise rotational motion is made, “COMMAND CHANNEL DOWN”, which is a command to select channel numbers one by one in order from top to bottom, is sent from the communication terminal 1 to the monitor 5 each time a predetermined rotation angle of the counterclockwise rotational motion is detected.

Selection of a channel can be confirmed by an “OK” motion. A channel selection command to select the channel number corresponding to the item that is highlighted when an “OK” motion is recognized is issued from the communication terminal 1 to the monitor 5. The monitor 5 tunes to the channel corresponding to the channel number contained in the received channel selection command. For example, when an “OK” motion is recognized while Channel 8 is highlighted, the communication terminal 1 issues “COMMAND SETCHANNEL No. 8” and the monitor 5 switches to the broadcast picture of channel 8.

When a “goodbye” motion is recognized or after a motion is unable to be recognized for a predetermined period of time, the communication terminal sends a command to stop providing the video image of the menu items to the monitor 5. In response to the command, the monitor 5 displays only the broadcast picture. If the user wants to display the menu items again, the user makes the first preliminary motion described above. In this case, because the input source of a video signal has already been selected, the communication terminal 1 may immediately instruct the monitor 5 to provide the video image of the menu items upon recognizing the first preliminary motion.

By requesting a first or second preliminary motion before displaying the menu items in this way, an accidental operation by an operator can be prevented and an operation that faithfully follows the intention of the operator can be readily implemented.

Functions of the communication terminal 1 may be included in a monitor 5 or other television receiver, or a personal computer having the functions of television and camera. In summary, the essence of the present invention is that a motion operation mode is entered in response to a particular motion of a particular object being recognized from a video image, then operations of various devices are controlled in accordance with various command motions recognized in a motion area being locked on. This function can be included in any of various other electronic devices besides a communication terminal 1.

What is claimed is:

1. A control apparatus which controls an electronic device, comprising:
a video image obtaining unit which continuously obtains a video signal a subject of which is a particular object;
a command recognition unit which recognizes a control command relating to control of the electronic device, the control command being represented by at least one of a particular shape and motion of the particular object from a video signal obtained by the video image obtaining unit;
a command mode setting unit which sets a command mode for accepting the control command; and
a control unit which controls the electronic device on the basis of a control command recognized by the command recognition unit, in response to the command mode setting unit setting the command mode.

2. The control apparatus according to claim 1, wherein
the command recognition unit recognizes an end command to end the command mode from a video signal obtained by the video image obtaining unit, the end command being represented by at least one of a particular shape and motion of the particular object; and
the command mode setting unit cancels the set command mode in response to the command recognition unit recognizing the end command.

3. The control apparatus according to claim 1, wherein
the command recognition unit recognizes a preliminary command from a video signal obtained by the video image obtaining unit, the preliminary command being represented by at least one of a particular shape and motion of the particular object; and
the command mode setting unit sets the command mode in response to the command recognition unit recognizing the preliminary command.

4. The control apparatus according to claim 1, wherein the command mode setting unit sets the command mode in response to a manual input operation instructing to set the command mode.

5. A control apparatus which controls an electronic device, comprising:
a video image obtaining unit which continuously obtains a video signal a subject of which is a particular object;
a command recognition unit which recognizes a preliminary command and a control command relating to control of the electronic device from a video signal obtained by the video image obtaining unit, the preliminary command and the control command being represented by at least one of a particular shape and motion of the particular object; and
a control unit which controls the electronic device on the basis of a control command recognized by the command recognition unit, in response to the command recognition unit recognizing the preliminary command;
wherein the command recognition unit tracks an area in which a preliminary command by the particular object is recognized from the video signal, and recognizes the control command from the area.

6. The control apparatus according to claim 5, further comprising a thinning unit which thins a video signal obtained by the video image obtaining unit;
wherein the command recognition unit recognizes the preliminary command from a video signal thinned by the thinning unit and recognizes the control command from a video signal obtained by the video image obtaining unit.

7. The control apparatus according to claim 5, further comprising an extraction unit which extracts feature information from the area;
wherein the command recognition unit tracks the area on the basis of feature information extracted by the extraction unit.

8. A control apparatus which controls an electronic device, comprising:
a video image obtaining unit which continuously obtains a video signal a subject of which is a particular object;
a command recognition unit which recognizes a preliminary command and a control command relating to control of the electronic device from a video signal obtained by the video image obtaining unit, the preliminary command and the control command being represented by at least one of a particular shape and motion of the particular object;
a command mode setting unit which sets a command mode for accepting the control command, in response to the command recognition unit recognizing the preliminary command; and
a control unit which controls the electronic device on the basis of the control command in response to the command mode setting unit setting the command mode;
wherein the command recognition unit, in response to the command mode setting unit setting the command mode, tracks an area in which a preliminary command by the particular object is recognized from the video signal and recognizes the control command from the tracked area.

9. The control apparatus according to claim 8, wherein
the command recognition unit tracks an area in which a first preliminary command by the particular object is recognized from the video signal, and recognizes the second preliminary command from the area; and
the command mode setting unit sets the command mode in response to the command recognition unit recognizing the first and second preliminary commands.

10. The control apparatus according to claim 9, wherein the preliminary command is represented by a shape of the particular object and the control command is represented by a motion of the object.

11. The control apparatus according to claim 9, wherein the first preliminary command is represented by wagging of a hand with a finger extended and the second preliminary command is represented by forming a ring by fingers.

12. The control apparatus according to claim 8, wherein the command recognition unit recognizes an end command to end the command mode from the video signal; and
the command mode setting unit cancels the set command mode in response to the command recognition unit recognizing the end command.

13. The control apparatus according to claim 12, wherein the end command is represented by a to-and-fro motion of the center of gravity, an end, or the entire outer surface of an image of the particular object.

14. The control apparatus according to claim 13, wherein the end command is represented by wagging of a hand with a plurality of fingers extended.

15. The control apparatus according to claim 1, wherein the command recognition unit recognizes a selection command to select a menu item that depends on a rotation movement direction and amount of rotation of the center of gravity, an end, or the entire outer surface of the particular object.

16. The control apparatus according to claim 5, wherein the command recognition unit recognizes a selection command to select a menu item that depends on a rotation movement direction and amount of rotation of the center of gravity, an end, or the entire outer surface of the particular object.

17. The control apparatus according to claim 8, wherein the command recognition unit recognizes a selection command to select a menu item that depends on a rotation movement direction and amount of rotation of the center of gravity, an end, or the entire outer surface of the particular object.

18. The control apparatus according to claim 15, wherein the selection command is represented by rotation of a hand with a finger extended.

19. The control apparatus according to claim 16, wherein the selection command is represented by rotation of a hand with a finger extended.

20. The control apparatus according to claim 17, wherein the selection command is represented by rotation of a hand with a finger extended.

21. The control apparatus according to claim 1, wherein the command recognition unit recognizes a selection confirmation command to confirm selection of a menu item from a particular shape of the particular object.

22. The control apparatus according to claim 5, wherein the command recognition unit recognizes a selection confirmation command to confirm selection of a menu item from a particular shape of the particular object.

23 The control apparatus according to claim 8, wherein the command recognition unit recognizes a selection confirmation command to confirm selection of a menu item from a particular shape of the particular object.

24. The control apparatus according to claim 21, wherein the selection confirmation command is represented by formation of a ring by fingers.

25. The control apparatus according to claim 22, wherein the selection confirmation command is represented by formation of a ring by fingers.

26. The control apparatus according to claim 23, wherein the selection confirmation command is represented by formation of a ring by fingers.

27. The control apparatus according to claim 1, further comprising a setting indicating unit which indicates status of setting of the command mode.

28. The control apparatus according to claim 8, further comprising a setting indicating unit which indicates status of setting of the command mode.

29. A control method for controlling an electronic device, comprising the steps of:
continuously obtaining a video signal a subject of which is a particular object;
recognizing a control command relating to control of the electronic device from a video signal obtained, the control command being represented by at least one of a particular shape and motion of the particular object;
setting a command mode for accepting the control command; and
controlling the electronic device on the basis of the control command, in response to setting of the command mode.

30. A control method for controlling an electronic device, comprising the steps of:
continuously obtaining a video signal a subject of which is a particular object;
recognizing a preliminary command represented by at least one of a particular shape or motion of the particular object from the video signal;
tracking an area in which the preliminary command is recognized from the video signal and recognizing a control command represented by at least one of a particular shape and motion of the particular object from the area; and
controlling the electronic device on the basis of the recognized control command.

31. A control method for controlling an electronic device, comprising the steps of:
continuously obtaining a video signal a subject of which is a particular object;
recognizing a preliminary command represented by at least one of a particular shape and motion of the particular object from a video signal obtained;
setting a command mode for accepting the control command, in response to recognition of the preliminary command;
in response to setting of the command mode, tracking an area in which the preliminary command is recognized and recognizing a control command relating to control of the electronic device from the tracked area; and
controlling the electronic device on the basis of the control command.

32. The control method according to claim 29, further comprising the step of indicating status of setting of the command mode.

33. The control method according to claim 31, further comprising the step of indicating status of setting of the command mode.

34. A program causing a computer to perform the control method according to claim 29.

35. A program causing a computer to perform the control method according to claim 30.

36. A program causing a computer to perform the control method according to claim 31.
